(19) United States
(12) Patent Application Publication
(10) Pub. No.: US 2025/0138970 A1
(43) Pub. Date: May 1, 2025

(54) SYSTEMS AND METHODS FOR AGGREGATING AND MAPPING INCIDENT CHARACTERISTICS INTO DAILY INCIDENT PROFILING

(71) Applicant: Fidelity Information Services, LLC, Jacksonville, FL (US)

(72) Inventors: John C. PLATAIS, Menomonee Falls, WI (US); Ranadhir GHOSH, St Johns, FL (US)

(21) Appl. No.: 18/498,675

(22) Filed: Oct. 31, 2023

(51) Int. Cl. G06F 11/30

(52) U.S. Cl. CPC G06F 11/3082; G06F 11/3058

(57) ABSTRACT

A computer implemented method for aggregating and mapping incident characteristics into a daily profile. The method includes: receiving a set of historical data objects indicating an occurrences of a set of incidents each associated with a set of configurable items; determining a single incident profile for each of the historical data objects; determining a consolidated single incident profile for each of the historical data objects; aggregating the consolidated single incident profiles at a day level; and clustering the aggregated consolidate single incident profile to determine a historic day profile cluster.

### TECHNICAL FIELD

Various embodiments of the present disclosure relate generally to processing incident data and, more particularly, to aggregating and mapping incident characteristics into daily incident profiles using feature engineering and multiple level clustering.

### BACKGROUND

Changes to any type of system creates some degree of risk that the system will not continue to perform as expected. Additionally, even if system performance is not immediately affected, a change to a system may cause later issues, and time may be lost to determine what caused the change in performance of the system.

For example, in software, deploying, refactoring, or releasing software code has different kinds of associated risk depending on what code is being changed. Not having a clear view of how vulnerable or risky a certain code deployment may be increases the risk of system outages. Deploying code always includes risks for a company, and platform modernization is a continuous process. A technology shift is a big event for any product, and entails a large risk and opportunity for a software company.

Outages and/or incidents cost companies money in service-level agreement payouts, but more importantly, wastes time for personnel via rework, and may risk adversely affecting a company's reputation with its customers. Highest costs are attributed to bugs reaching production, including a ripple effect and a direct cost on all downstream teams. Also, after a modification has been deployed, an incident team may waste time determining what caused a change in performance of a system.

IT operations change requests for changes across the IT landscape can have varying levels of risk and impact. In large IT organizations, change-caused incidents may make up 70-80% of critical incidents, and hence cause a significant burden on IT teams. Modern IT architectures have become increasingly complex. Resolving recurring incidents in a large system across the IT landscape frequently involves decentralized personnel and systems, and individual ticket and time-separated resolutions, resulting in significant inefficiencies in large IT organizations. Understanding the different types of incidents within a system on a daily basis from various perspective may assist in resolving incidents.

The present disclosure is directed to overcoming one or more of these above-referenced challenges.

### SUMMARY OF THE DISCLOSURE

In some aspects, the techniques described herein relate to a method for aggregating and mapping incident characteristics into a daily profile, the method including: receiving a set of historical data objects indicating an occurrences of a set of incidents each associated with a set of configurable items; determining a single incident profile for each of the historical data objects; determining a consolidated single incident profile for each of the historical data objects; aggregating the consolidated single incident profiles at a day level; and clustering the aggregated consolidate single incident profile to determine a historic day profile cluster.

In some aspects, the techniques described herein relate to a method, wherein the set of historical data objects represents the occurrences of a set of incidents over at least a month.

In some aspects, the techniques described herein relate to a method, where determining a single incident profile for each of the historical data objects includes: determining features from text descriptions of the historical data objects; performing a clustering algorithm on the features; and determining clusters for each of the historical data objects.

In some aspects, the techniques described herein relate to a method further including: determining a first set of features utilizing term frequency-inverse document frequency vectorization; determining a second set of features utilizing noun phrase extraction; and determining a third set of features utilizing verb phrase extraction.

In some aspects, the techniques described herein relate to a method wherein the clustering algorithms are applied separately on the first set of features, the second set of feature, and the third set of features.

In some aspects, the techniques described herein relate to a method, wherein determining a consolidated single incident profile for each of the historical data objects further includes: applying a clustering algorithm on the consolidated single incident profile; and saving a single incident cluster for each historical data object.

In some aspects, the techniques described herein relate to a method, wherein aggregating the consolidated single incident profiles at a day level further includes: performing a clustering algorithm on the consolidated single incident profiles, wherein the single incident profiles at a day level has an aggregation of all single incident clusters for each historical data object for a day.

In some aspects, the techniques described herein relate to a method further including outputting the historic day profile clusters for a set period of time.

In some aspects, the techniques described herein relate to a method, further including determining an amount of days within each of the determined historic day profile clusters.

In some aspects, the techniques described herein relate to a system for aggregating and mapping incident characteristics into a daily profile, the system including: a memory having processor-readable instructions stored therein; and at least one processor configured to access the memory and execute the processor-readable instructions to perform operations including: receiving a set of historical data objects indicating an occurrences of a set of incidents each associated with a set of configurable items; determining a single incident profile for each of the historical data objects; determining a consolidated single incident profile for each of the historical data objects; aggregating the consolidated single incident profiles at a day level; and clustering the aggregated consolidate single incident profile to determine a historic day profile cluster.

In some aspects, the techniques described herein relate to a system, wherein the set of historical data objects represents the occurrences of a set of incidents over at least a month.

In some aspects, the techniques described herein relate to a system, where determining a single incident profile for each of the historical data objects includes: determining features from text descriptions of the historical data objects; performing a clustering algorithm on the features; and determining clusters for each of the historical data objects.

In some aspects, the techniques described herein relate to a system, further includes: determining a first set of features utilizing term frequency-inverse document frequency vectorization; determining a second set of features utilizing noun phrase extraction; and determining a third set of features utilizing verb phrase extraction.

In some aspects, the techniques described herein relate to a system, wherein the clustering algorithms are applied separately on the first set of features, the second set of feature, and the third set of features.

In some aspects, the techniques described herein relate to a system, wherein determining a consolidated single incident profile for each of the historical data objects further includes: applying a clustering algorithm on the consolidated single incident profile; and saving a single incident cluster for each historical data object.

In some aspects, the techniques described herein relate to a system, wherein aggregating the consolidated single incident profiles at a day level further includes performing a clustering algorithm on the consolidated single incident profiles, wherein the single incident profiles at a day level has an aggregation of all single incident clusters for each historical data object for a day.

In some aspects, the techniques described herein relate to a system, further including outputting the historic day profile clusters for a set period of time.

In some aspects, the techniques described herein relate to a system, further including determining an amount of days within each of the determined historic day profile clusters.

In some aspects, the techniques described herein relate to a non-transitory computer readable medium storing processor-readable instructions which, when executed by at least one processor, cause the at least one processor to perform operations including: receiving a set of historical data objects indicating an occurrences of a set of incidents each associated with a set of configurable items; determining a single incident profile for each of the historical data objects; determining a consolidated single incident profile for each of the historical data objects; aggregating the consolidated single incident profiles at a day level; and clustering the aggregated consolidate single incident profile to determine a historic day profile cluster.

In some aspects, the techniques described herein relate to a non-transitory computer readable medium, wherein the set of historical data objects represents the occurrences of a set of incidents over at least a month.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system overview for a data pipeline for transferring data to an artificial intelligence model to aggregate and map incidents in a system, according to one or more embodiments.

FIG. 2A may depicts an exemplary flowchart 200 for aggregating and mapping incident characteristics into daily incident profiles, according to one or more embodiments.

FIG. 3A depicts an exemplary method of determining a daily profile of incidents, according to one or more embodiments.

FIG. 3B depicts an exemplary graph of daily incidents with assigned features, according to one or more embodiments.

FIG. 3C depicts an exemplary graph of a clustered set of daily incidents with assigned features, according to one or more embodiments.

FIG. 4A depicts an exemplary method of determining a single incident profile, according to one or more embodiments.

FIG. 4B depicts an exemplary graph of features determined using a term frequency-inverse document frequency (TF-IDF) vectorization for single incident profiles, according to one or more embodiments.

FIG. 4C depicts an exemplary graph of features determined using a noun phrase extraction for single incident profiles, according to one or more embodiments.

FIG. 4D depicts an exemplary graph of features determined using a verb phrase extraction for single incident profiles, according to one or more embodiments.

FIG. 4E depicts an exemplary graph of clustered features determined using a term frequency-inverse document frequency (TF-IDF) vectorization for single incident profiles, according to one or more embodiments.

FIG. 4F depicts an exemplary graph of clustered features determined using a noun phrase extraction for single incident profiles, according to one or more embodiments.

FIG. 4G depicts an exemplary graph of clustered features determined using a verb phrase extraction for single incident profiles, according to one or more embodiments.

FIG. 5A depicts an exemplary flowchart for creating consolidated single incident profile, according to one or more embodiments.

FIG. 5B depicts an exemplary graph of consolidated single incident profiles, according to one or more embodiments.

FIG. 6A depicts an exemplary flowchart for aggregating consolidated single incident profiles at a day level, according to one or more embodiments.

FIG. 6B depicts an exemplary graph of aggregated consolidated single incident profiles at a day level, according to one or more embodiments.

FIG. 7A depicts an exemplary flowchart for determining historic day profile clusters, according to one or more embodiments.

FIG. 7B depicts an exemplary graph of the frequency of particular historic day profile clusters, according to one or more embodiments.

FIG. 7C depicts an exemplary graph of the determined historic day profile clusters, according to one or more embodiments.

FIG. 8 depicts exemplary graph displaying a comparison between two days of incident data, according to one or more embodiments.

FIG. 9A depicts an exemplary graph output of the repeating incidents for a particular configurable item on an exemplary day, according to one or more embodiments.

FIG. 9B depicts an exemplary graph output of the duplicate tickets for incidents on an exemplary day, according to one or more embodiments.

FIG. 10A depicts an exemplary graph output of the top contributing alerts for incidents on an exemplary day, according to one or more embodiments.

FIG. 10B depicts an exemplary graph output of the minimum time gap between incidents for the same configurable item, according to one or more embodiments.

FIG. 11 depicts an exemplary graph output of the frequently occurring incidents in an exemplary day, according to one or more embodiments.

FIG. 12 of a flowchart of a method for aggregating and mapping incident characteristics into a daily profile.

FIG. 13 illustrates a computer system 1300 for executing the techniques described herein, according to one or more embodiments of the present disclosure.

### DETAILED DESCRIPTION OF EMBODIMENTS

Various embodiments of the present disclosure relate generally to processing incident data, more particularly, to aggregating and mapping incident characteristics into daily incident profiling using feature engineering and multiple level clustering.

The subject matter of the present disclosure will now be described more fully with reference to the accompanying drawings that show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Software companies have been struggling to avoid outages from incidents that may be caused by upgrading software or hardware components, or changing a member of a team, for example. An incident may be defined as an unexpected event that disrupts the operation of an IT service. Incidents may be manually reported by customers or personnel, may be automatically logged by internal systems, or may be captured in other ways. An incident may occur from factors such as hardware failure, software failure, software bugs, human error, and/or cyber attacks. Deploying, refactoring, or releasing software code may for example cause an incident. An incident may be detected during, for example, an outage or a performance change. An incident may include characteristics, where an incident characteristic may refer to the quality or traits associated with an incident. For example, incident characteristics may include, but is not limited to, the severity of an incident, the urgency of an incident, the complexity of an incident, the scope of an incident, the cause of an incident, and/or what configurable item corresponds to the incident (e.g., what systems/platforms/products etc. are affected by the incident), how it is described in freeform text, what business segment is effected, what category/subcategory is affected, and/or what assigned group is the incident.

Understanding the different types of incidents within a system on a daily basis from various perspective may assist in resolving incidents. For example, it may be useful to define, characterize, or group a particular incident or set of incidents that are received by a system. It may further be valuable to group and define all incidents received by a system for a particular day. This may be a complex task as an incident may include many different types of characteristics that are heterogeneous in nature. For example an incident may include metadata including a field like short description that includes free form text fields, affected CI, timing of opening, incident cause code, priority, etc. Comparing, grouping, or mapping incidents based on individual aspects/fields may not capture the complexity of accurately grouping related incidents.

One or more embodiments may include systems and methods configured to group and define incidents at both a single incident profile level and also a daily profile. The profiles may be based on the multi-dimensional characteristics of the incidents and the profiles may provide insight to an incident management. The daily profile may be compared to and grouped with previously determined daily profiles (e.g., by using feature creation and clustering techniques). The daily profile groups may for example assist with defining a benchmark that define a daily profile as a normal operation day. The benchmark for a normal operation day may for example refer to the daily profile grouping with the mount amount of days included. The system may further be configured to match a particular day profile with one or more historical day profile. The day profiles and the single incident profiles, along with the matching of day profiles, may provide valuable information to an incident management program, where an incident management program is tasked with responding to and resolving incidents.

One or more embodiments of the systems and methods described herein may be able to reduce a burden on a company to identify, aggregate, map, and ultimately resolve incidents. One or more embodiments may, process daily incident data to create a daily incident profile. The daily incident profile may assist with an IT management system better understanding the incidents received for a day on a more holistic level.

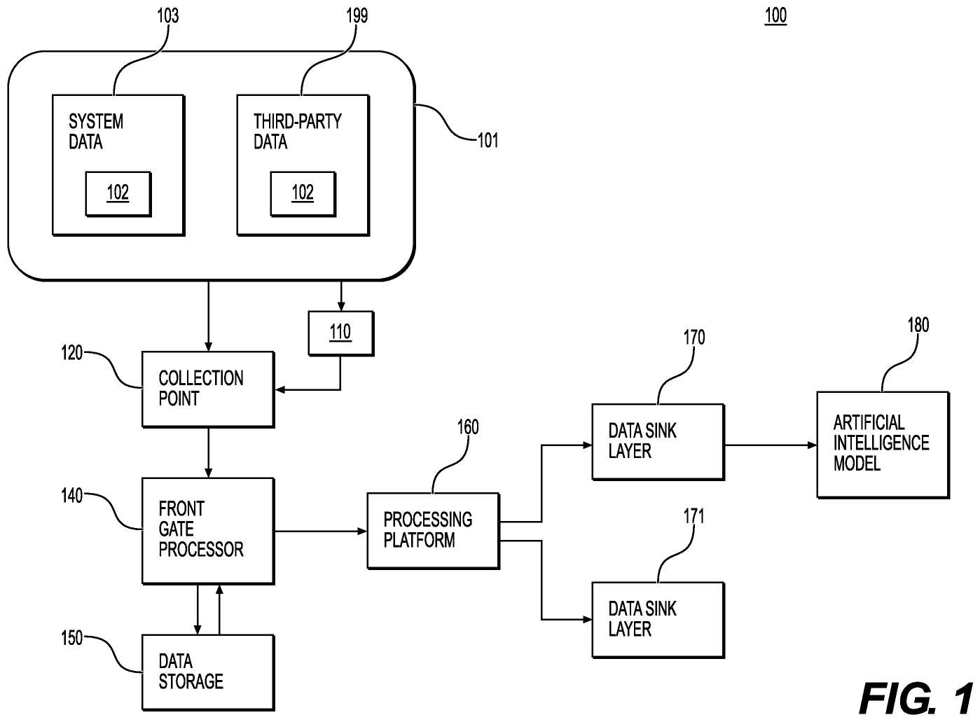

FIG. 1 depicts an exemplary system overview for a data pipeline for an artificial intelligence model to predict and troubleshoot incidents in a system, according to one or more embodiments. For example, the data pipeline system 100, may aggregate and send incident data to an artificial intelligence model 180, wherein the artificial intelligence model 180 is configured to aggregate and map incident characteristics into daily incident proles using feature engineering and/or multiple level clustering. The data pipeline system 100 may be a platform with multiple interconnected components. The data pipeline system 100 may include one or more servers, intelligent networking devices, computing devices, components, and corresponding software for aggregating and processing data.

As shown in FIG. 1, a data pipeline system 100 may include a data source 101, a collection point 120, a secondary collection point 110, a front gate processor 140, data storage 150, a processing platform 160, a data sink layer 170, a data sink layer 171, and an artificial intelligence module 180.

The data source 101 may include in-house data 103 and third party data 199. The in-house data 103 may be a data source directly linked to the data pipeline system 100. Third party data 199 may be a data source connected to the data pipeline system 100 externally as will be described in greater detail below.

Both the in-house data 103 and third party data 199 of the data source 101 may include incident data 102. Incident data 102 may include incident reports with information for each incident provided with one or more of an incident number, closed date/time, category, close code, close note, long description, short description, root cause, or assignment group. Incident data 102 may include incident reports with information for each incident provided with one or more of an issue key, description, summary, label, issue type, fix version, environment, author, or comments. Incident data 102 may include incident reports with information for each incident provided with one or more of a file name, script name, script type, script description, display identifier, message, committer type, committer link, properties, file changes, or branch information. Incident data 102 may include one or more of real-time data, market data, performance data, historical data, utilization data, infrastructure data, or security data. These are merely examples of information that may be used as data, and the disclosure is not limited to these examples.

Incident data 102 may be generated automatically by monitoring tools that generate alerts and incident data to provide notification of high-risk actions, failures in IT environment, and may be generated as tickets. Incident data may include metadata, such as, for example, text fields, identifying codes, and time stamps.

The in-house data 103 may be stored in a relational database including an incident table. The incident table may be provided as one or more tables, and may include, for example, one or more of problems, tasks, risk conditions, incidents, or changes. The relational database may be stored in a cloud. The relational database may be connected through encryption to a gateway. The relational database may send and receive periodic updates to and from the cloud. The cloud may be a remote cloud service, a local service, or any combination thereof. The cloud may include a gateway connected to a processing API configured to transfer data to the collection point 120 or a secondary collection point 110. The incident table may include incident data 102.

Data pipeline system 100 may include third party data 199 generated and maintained by third party data producers. Third party data producers may produce incident data 102 from Internet of Things (IoT) devices, desktop-level devices, and sensors. Third party data producers may include but are not limited to Tryambak, Appneta, Oracle, Prognosis, ThousandEyes, Zabbix, ServiceNow, Density, Dyatrace, etc. The incident data 102 may include metadata indicating that the data belongs to a particular client or associated system.

The data pipeline system 100 may include a secondary collection point 110 to collect and pre-process incident data 102 from the data source 101. The secondary collection point 110 may be utilized prior to transferring data to a collection point 120. The secondary collection point 110 point may for example be an Apache Minifi software. In one example, the secondary collection point 110 may run on a microprocessor for a third party data producer. Each third party data producer may have an instance of the secondary collection point 110 running on a microprocessor. The secondary collection point 110 may support data formats including but not limited to JSON, CSV, Avro, ORC, HTML, XML, and Parquet. The secondary collection point 110 may encrypt incident data 102 collected from the third party data producers. The secondary collection point 110 may encrypt incident data, including, but not limited to, Mutual Authentication Transport Layer Security (mTLS), HTTPs, SSH, PGP, IPsec, and SSL. The secondary collection point 110 may perform initial transformation or processing of incident data 102. The secondary collection point 110 may be configured to collect data from a variety of protocols, have data provenance generated immediately, apply transformations and encryptions on the data, and prioritize data.

The data pipeline system 100 may include a collection point 120. The collection point 120 may be a system configured to provide a secure framework for routing, transforming, and delivering data across from the data source 101 to downstream processing devices (e.g., the front gate processor 140). The collection point 120 may for example be a software such as Apache NiFi. The collection point 120 may receive raw data and the data's corresponding fields such as the source name and ingestion time. The collection point 120 may run on a Linux Virtual Machine (VM) on a remote server. The collection point 120 may include one or more nodes. For example, the collection point 120 may receive incident data 102 directly from the data source 101. In another example, the collection point 120 may receive incident data 102 from the secondary collection point 110. The secondary collection point 110 may transfer the incident data 102 to the collection point 120 using, for example, Site-to-Site protocol. The collection point 120 may include a flow algorithm. The flow algorithm may connect different processors, as described herein, to transfer and modify data from one source to another. For each third party data producer, the collection point 120 may have a separate flow algorithm. Each flow algorithm may include a processing group. The processing group may include one or more processors. The one or more processors may, for example, fetch incident data 102 from the relational database. The one or more processors may utilize the processing API of the in-house data 103 to make an API call to a relational database to fetch incident data 102 from the incident table. The one or more processors may further transfer incident data 102 to a destination system such as a front gate processor 140. The collection point 120 may encrypt data through HTTPS, Mutual Authentication Transport Layer Security (mTLS), SSH, PGP, IPsec, and/or SSL, etc. The collection point 120 may support data formats including but not limited to JSON, CSV, Avro, ORC, HTML, XML, and Parquet. The collection point 120 may be configured to write messages to clusters of a front gate processor 140 and communication with the front gate processor 140.

The data pipeline system 100 may include a distributed event streaming platform such as a front gate processor 140. The front gate processor 140 may be connected to and configured to receive data from the collection point 120. The front gate processor 140 may be implemented in an Apache Kafka cluster software system. The front gate processor 140 may include one or more message brokers and corresponding nodes. The message broker may for example be an intermediary computer program module that translates a message from the formal messaging protocol of the sender to the formal messaging protocol of the receiver. The message broker may be on a single node in the front gate processor 140. A message broker of the front gate processor 140 may run on a virtual machine (VM) on a remote server. The collection point 120 may send the incident data 102 to one or more of the message brokers of the front gate processor 140. Each message broker may include a topic to store similar categories of incident data 102. A topic may be an ordered log of events. Each topic may include one or more sub-topics. For example, one sub-topic may store incident data 102 relating to network problems and another topic may store incident data 102 related to security breaches from third party data producers. Each topic may further include one or more partitions. The partitions may be a systematic way of breaking the one topic log file into many logs, each of which can be hosted on a separate server. Each partition may be configured to store as much as a byte of incident data 102. Each topic may be partitioned evenly between one or more message brokers to achieve load balancing and scalability. The front gate processor 140 may be configured to categorize the received data into a plurality of client categories, thereby forming a plurality of datasets associated with the respective client categories. These datasets may be stored separately within the storage device as described in greater detail below. The front gate processor 140 may further transfer data to storage and to processors for further processing.

For example, the front gate processor 140 may be configured to assign particular data to a corresponding topic. Alert sources may be assigned to an alert topic, and incident data may be assigned to an incident topic. Change data may be assigned to a change topic. Problem data may be assigned to a problem topic.

The data pipeline system 100 may include a software framework for data storage 150. The data storage 150 may be configured for long term storage and distributed processing. The data storage 150 may be implemented using, for example, Apache Hadoop. The data storage 150 may store incident data 102 transferred from the front gate processor 140. In particular, data storage 150 may be utilized for distributed processing of incident data 102, and Hadoop distributed file system (HDFS) within the data storage may be used for organizing communications and storage of incident data 102. For example, the HDFS may replicate any node from the front gate processor 140. This replication may protect against hardware or software failures of the front gate processor 140. The processing may be performed in parallel on multiple servers simultaneously.

The data storage 150 may include an HDFS that is configured to receive the metadata (e.g., incident data). The data storage 150 may further process the data utilizing a MapReduce algorithm. The MapReduce algorithm may allow for parallel processing of large data sets. The data storage 150 may further aggregate and store the data utilizing Yet Another Resource Negotiation (YARN). YARN may be used for cluster resource management and planning tasks of the stored data. For example, a cluster computing framework, such as the processing platform 160, may be arranged to further utilize the HDFS of the data storage 150. For example, if the data source 101 stops providing data, the processing platform 160 may be configured to retrieve data from the data storage 150 either directly or through the front gate processor 140. The data storage 150 may allow for the distributed processing of large data sets across clusters of computers using programming models. The data storage 150 may include a master node and an HDFS for distributing processing across a plurality of data nodes. The master node may store metadata such as the number of blocks and their locations. The main node may maintain the file system namespace and regulate client access to said files. The main node may comprise files and directories and perform file system executions such as naming, closing, and opening files. The data storage 150 may scale up from a single server to thousands of machines, each offering local computation and storage. The data storage 150 may be configured to store the incident data in an unstructured, semi-structured, or structured form. In one example, the plurality of datasets associated with the respective client categories may be stored separately. The master node may store the metadata such as the separate dataset locations.

The data pipeline system 100 may include a real-time processing framework, e.g., a processing platform 160. In one example, the processing platform 160 may be a distributed dataflow engine that does not have its own storage layer. For example, this may be the software platform Apache Flink. In another example, the software platform Apache Spark may be utilized. The processing platform 160 may support stream processing and batch processing. Stream processing may be a type of data processing that performs continuous, real-time analysis of received data. Batch processing may involve receiving discrete data sets processed in batches. The processing platform 160 may include one or more nodes. The processing platform 160 may aggregate incident data 102 (e.g., incident data 102 that has been processed by the front gate processor 140) received from the front gate processor 140. The processing platform 160 may include one or more operators to transform and process the received data. For example, a single operator may filter the incident data 102 and then connect to another operator to perform further data transformation. The processing platform 160 may process incident data 102 in parallel. A single operator may be on a single node within the processing platform 160. The processing platform 160 may be configured to filter and only send particular processed data to a particular data sink layer. For example, depending on the data source of the incident data 102 (e.g., whether the data is in-house data 103 or third party data 199), the data may be transferred to a separate data sink layer (e.g., data sink layer 170, or data sink layer 171). Further, additional data that is not required at downstream modules (e.g., at the artificial intelligence module 180) may be filtered and excluded prior to transferring the data to a data sink layer.

The processing platform 160 may perform three functions. First, the processing platform 160 may perform data validation. The data's value, structure, and/or format may be matched with the schema of the destination (e.g., the data sink layer 170). Second, the processing platform 160 may perform a data transformation. For example, a source field, target field, function, and parameter from the data may be extracted. Based upon the extracted function of the data, a particular transformation may be applied. The transformation may reformat the data for a particular use downstream. A user may be able to select a particular format for downstream use. Third, the processing platform 160 may perform data routing. For example, the processing platform 160 may select the shortest and/or most reliable path to send data to a respective sink layer (e.g., sink layer 170 and/or sink layer 171).

In one example, the processing platform 160 may be configured to transfer particular sets of data to a data sink layer. For example, the processing platform 160 may receive input variables for a particular artificial intelligence module 180. The processing platform 160 may then filter the data received from the front gate processor 140 and only transfer data related to the input variables of the artificial intelligence module 180 to a data sink layer.

The data pipeline system 100 may include one or more data sink layers (e.g., data sink layer 170 and data sink layer 171). Incident data 102 processed from processing platform 160 may be transmitted to and stored in data sink layer 170. In one example, the data sink layer 171 may be stored externally on a particular client's server. The data sink layer 170 and data sink layer 171 may be implemented using a software such as, but not limited to, PostgreSQL, HIVE, Kafka, OpenSearch, and Neo4j. The data sink layer 170 may receive in-house data 103, which have been processed and received from the processing platform 160. The data sink layer 171 may receive third party data 199, which have been processed and received from the processing platform 160. The data sink layers may be configured to transfer incident data 102 to an artificial intelligence module 180. The data sink layers may be data lakes, data warehouses, or cloud storage systems. Each data sink layer may be configured to store incident data 102 in both a structured or unstructured format. Data sink layer 170 may store incident data 102 with several different formats. For example, data sink layer 170 may support data formats such as JavaScript Objection Notation (JSON), comma-separated value (CSV), Avro, Optimized Row Columnar (ORC), Hypertext Markup Language (HTML), Extensible Markup Language (XML), or Parquet, etc. The data sink layer (e.g., data sink layer 170 or data sink layer 171), may be accessed by one or more separate components. For example, the data sink layer may be accessed by a Non-structured Query language (“NoSQL”) database management system (e.g., a Cassandra cluster), a graph database management system (e.g., Neo4j cluster), further processing programs (e.g., Kafka+Flink programs), and a relation database management system (e.g., postgres cluster). Further processing may thus be performed prior to the processed data being received by an artificial intelligence module 180.

The data pipeline system 100 may include an artificial intelligence module 180. The artificial intelligence module 180 may include a machine-learning component. The artificial intelligence module 180 may use the received data in order to train and/or use a machine learning model. The machine learning model may be, for example, a neural network. Nonetheless, it should be noted that other machine learning techniques and frameworks may be used by the artificial intelligence module 180 to perform the methods contemplated by the present disclosure. For example, the systems and methods may be realized using other types of supervised and unsupervised machine learning techniques such as regression problems, random forest, cluster algorithms, principal component analysis (PCA), reinforcement learning, or a combination thereof. The artificial intelligence module 180 may be configured to extract and receive data from the data sink layer 170.

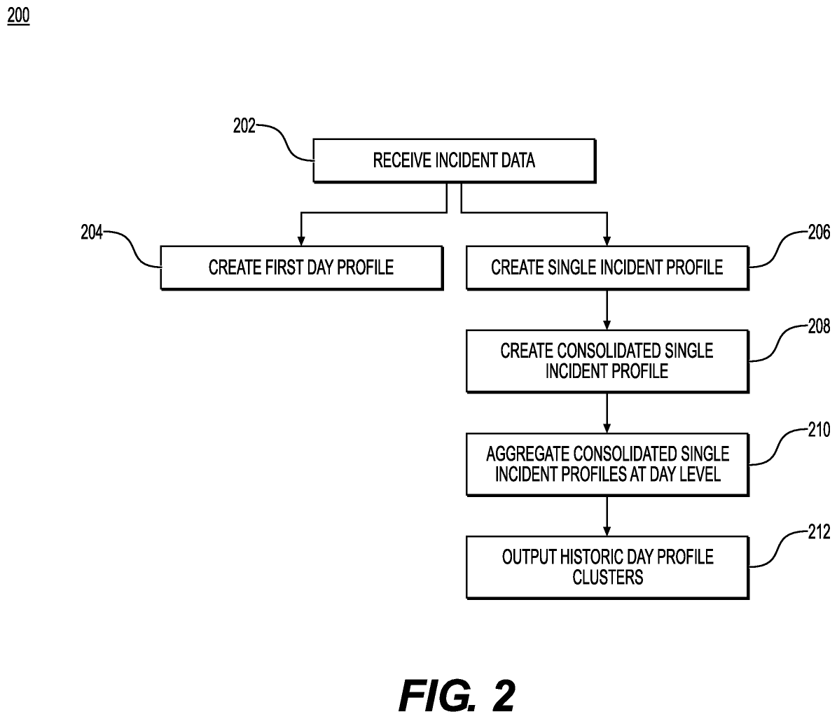

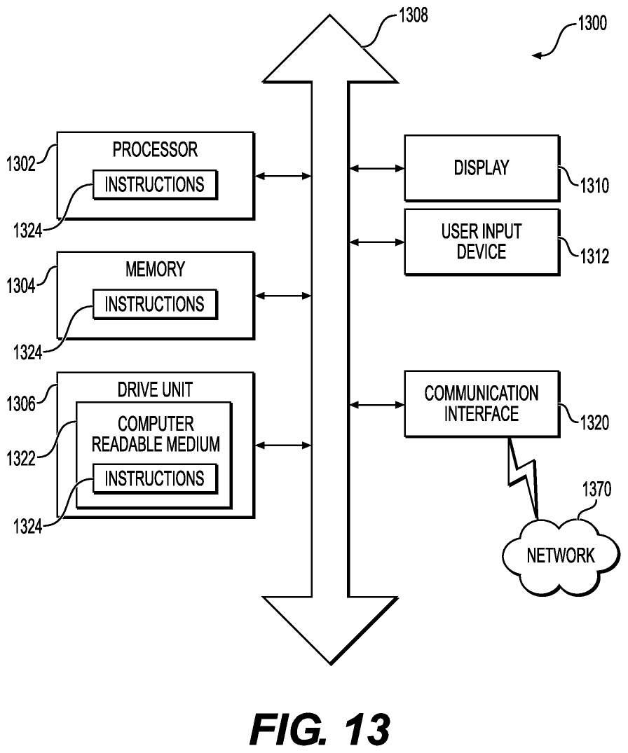

FIG. 2A may depicts an exemplary flowchart 200 for aggregating and mapping incident characteristics into daily incident profiles, according to one or more embodiments. The process/methods described in FIG. 2A may be implemented by the data pipeline system 100 of FIG. 1 and/or by the computer system 1300 of FIG. 13.

At step 202, incident data may be received and filtered. Incident data may include incident reports with information for each incident provided with one or more of an incident number, closed date/time, category, close code, close note, long description, short description, root cause, or assignment group. Incident data may include incident reports with information for each incident provided with one or more of an issue key, description, summary, label, issue type, fix version, environment, author, or comments. Incident data may further include incident cause code, priority, awaiting information, and/or assignment group within the text descriptions. Incident data may include incident reports with information for each incident provided with one or more of a file name, script name, script type, script description, display identifier, message, committer type, committer link, properties, file changes, or branch information. Incident data may include one or more of real-time data, market data, performance data, historical data, utilization data, infrastructure data, or security data. These are merely examples of information that may be used as data, and the disclosure is not limited to these examples. Incident data, for may for example within the short description, include all characteristic information described above. This may include the severity of an incident, the urgency of an incident, the complexity of an incident, the scope of an incident, the cause of an incident, and/or what configurable item corresponds to the incident (e.g., what systems/platforms/products etc. are affected by the incident), how it is described in freeform text, what business segment is effected, what category/subcategory is affected, and/or what assigned group is the incident. For example, the characteristic data of the incident data may be extracted from the description of the incident at this step for further processing. In one example, the incident data may be filtered to provide an identifier number, the date and time of an incident, the configurable item (CI) affected by the incident, the short description of the incident, and the priority level of an incident. These may all be saved for further analysis. The configurable item (CI) may refer to (1) a product; (2) an allocated component of a product, or (3) a system that satisfies an end use function, has distinct requirements, has functionality and/or product relationships, and/or is designated for distinct control in the configuration management system. When an incident occurs, it may occur for a particular configurable item.

The data may further have been filtered to provide incidents and their corresponding external systems (e.g., their configurable item). In another example, the incident data may be received by an electronic network, such as the Internet, through one or more computers, servers, and/or handheld mobile devices. The electronic network may be connected so as to provide incident data generated automatically by an external system by monitoring tools that generate alerts and incident data to provide notification of high-risk actions, failures in IT environment, and may be generated as tickets.

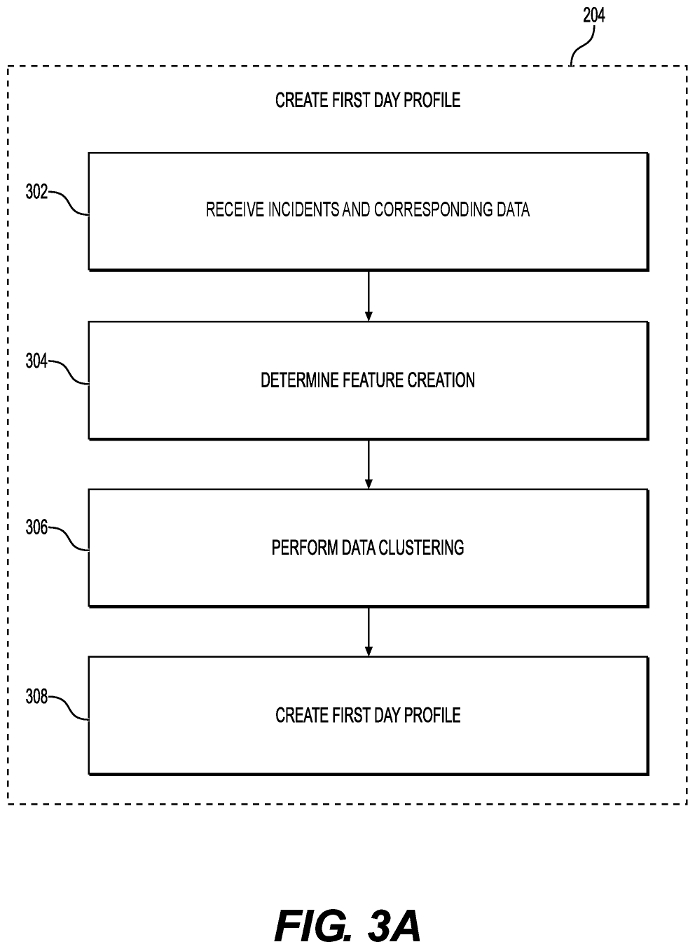

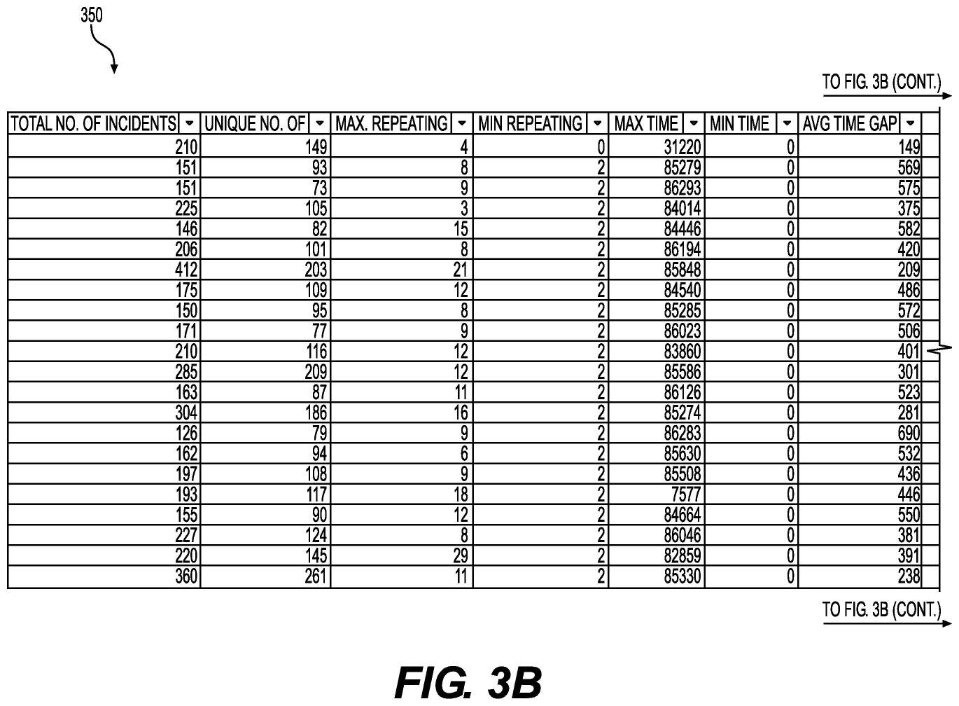

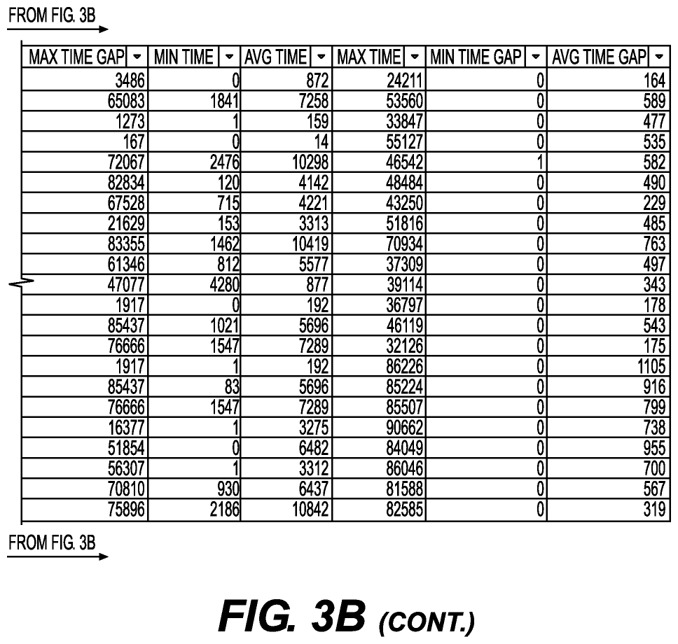

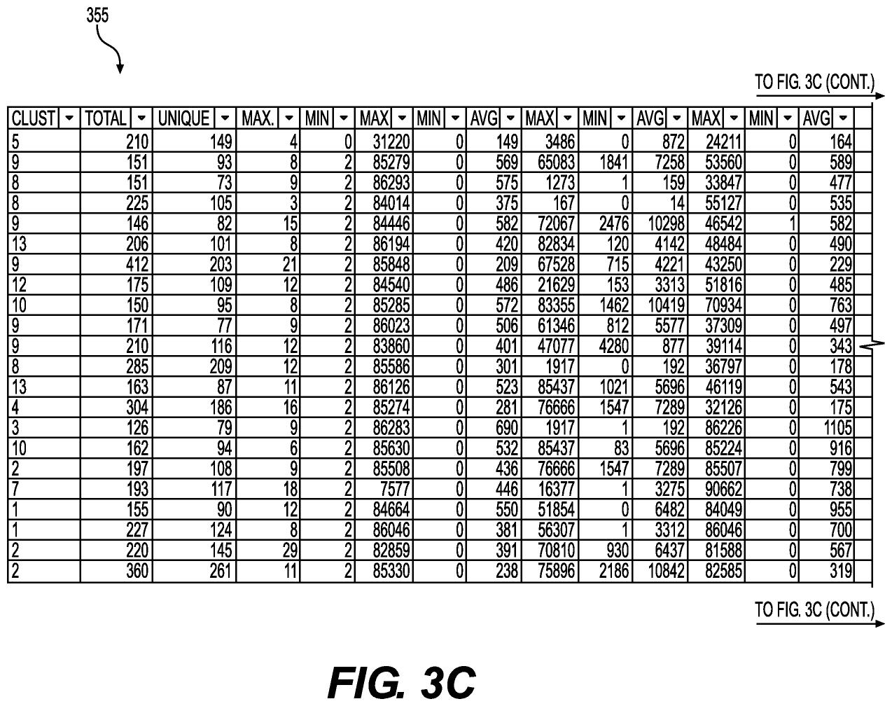

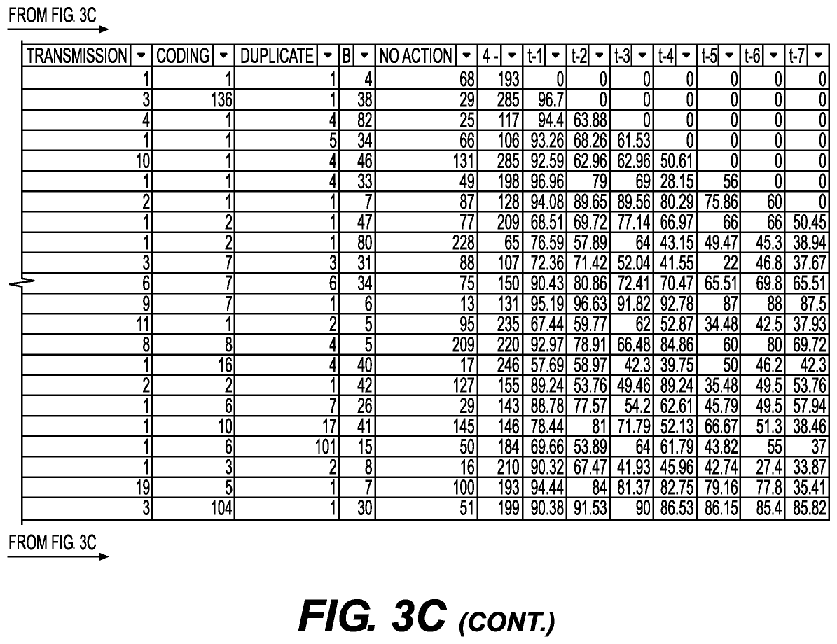

After step 202, the system described herein (e.g., system 100) may create a day profile at step 204. Step 204 may for example be further defined in FIG. 3A.

FIG. 3A depicts an exemplary method of determining a daily profile of incidents, according to one or more embodiments.

At step 302, a system (e.g., system 100) may receive incident data (e.g., from step 202) from the data pipeline (e.g., from the data sink layer 170 of FIG. 1). The incident data may include all incident data received for a particular time period. For example, incident data may be received by the system for a set period of months or years. It may be necessary for at least a weeks worth of incident data to be analyzed to determine a day profile. The incident data may include many individual incidents and each incident's corresponding characteristics. The incident characteristics may include the following, but is not limited to an incident number, date and time of the incident, a short description of the incident, and priority information. The short description may be free form text that contains additional information about the incident such as the configuration item (“CI”), what businesses are effected by the incident, what type of category, sub-category, and who is assigned groups for the particular incident.

At step 304, a set of daily features may be determined for one or more days (e.g., feature creation). The daily features may for example be key aspects of information regarding the incidents for a day. For example, the daily features determined for a particular day may include, but are not limited to: (1) total no. of incidents per day; (2) unique no. of CI per day; (3) Max. repeating CI per day; (4) Min repeating CI per day; (5) Max time gap b/w opened per day in SEC; (6) Min time gap b/w Opened per day in SEC; (7) Avg time gap b/w opened per day in SEC; (8) Max time gap between same Cls in SEC; (9) Min time gap between same Cis in SEC; (10) Avg time gap between same Cis in SEC; (11) Max time gap between unique Cis in SEC; (12) Min time gap between unique Cis in SEC; (13) Avg time gap between unique Cis in SEC; and (14) Percentage of unique Cl's with a time lag of (t−1), (t−2), . . . , (t−7). These features may help describe the nature of incidents received throughout a day. CI may refer to a configurable item as discussed above. An SEC may refer to a “security control” and may be a measure or process that is implemented to protect a CI from unauthorized access, use, disclosure, disruption, modification, or destruction. The features may be extracted from the incident data received at step 302. For example, the information may be extracted from the short descriptions of the short descriptions for each incident, the timing information, and the CI associated with each incident. The features may for example be compiled and determined for each day of incident data. This may be referred to as aggregation of features on a day level. FIG. 3B may for example show a graph 350, wherein each rows in the X-axis represents a particular day's incident data and each column of a Y-axis represents a feature. FIG. 3B may display a graph 350 with an exemplary set of feature information for twenty two days of received incident data. The graph may display how many recordings of each daily feature took place each day. Thus graph 350 may display the aggregation of features for an exemplary set of incidents received by a system over twenty two days.

At step 306, a first clustering algorithm may be performed on the daily features determined at step 304 (e.g., on the features for each day). In addition to the features from step 304, each day may record the number of “incident cause codes” and the number of X priority associated with all incidents for a day. These may be compiled and stored as well. The first clustering algorithm may for example be applied to the set of features from step 304 for multiple days, along with the incident cause code, and priority numbers for a day, for a set of days.

For example, the clustering algorithms may be applied by the artificial intelligence model 180. The clustering algorithm may be a type of unsupervised machine learning algorithm that groups data points (e.g., groups days) based on the group's data points (e.g., based on the daily features). The clustering may compute the similarity between data points and assign data points to clusters based on the data point's similarity. The clustering may include performing algorithms including, but not limited to, affinity propagation, Agglomerative Hierarchical Clustering, Balanced Iterative Reducing and Clustering using Hierarchies (BIRCH), Density-Based Spatial Clustering of Applications with Noise (DBSCAN), Gaussian Mixture Models (GMM), K-means, mean shift clustering, mini-batch K-means, OPTICS, or spectral clustering. The cluster algorithm may then output a set of clusters, wherein based on having similar features, incident cause codes for a day, and similar amounts of set priority levels for a day, a set of first daily clusters may be created.

FIG. 3C may for example display a chart 355, which is an updated version of the graph 350 in 5B that includes the assigned cluster determined at step 306 for each day. For example, the far left Y column may now depict what cluster each day has been assigned to by the clustering algorithm. Thus, a first daily profile cluster may be assigned to each of the days.

Step 308 may for example be recording the “first daily profile clusters” for each of the days. These first daily profile clusters may for example be a cluster assigned to a particular day profile. A day having been assigned the same cluster (e.g., the same day profile) may mean that the day has similar features (e.g., the features from step 304). For example, a particular cluster may have a low number of incidents and a high max repeating CI per day.

The system may for example be configured to store and save all days, and their corresponding features for a particular cluster. The system may further be configured to find the average of each of the daily features to determine summaries of the particular day profiles.

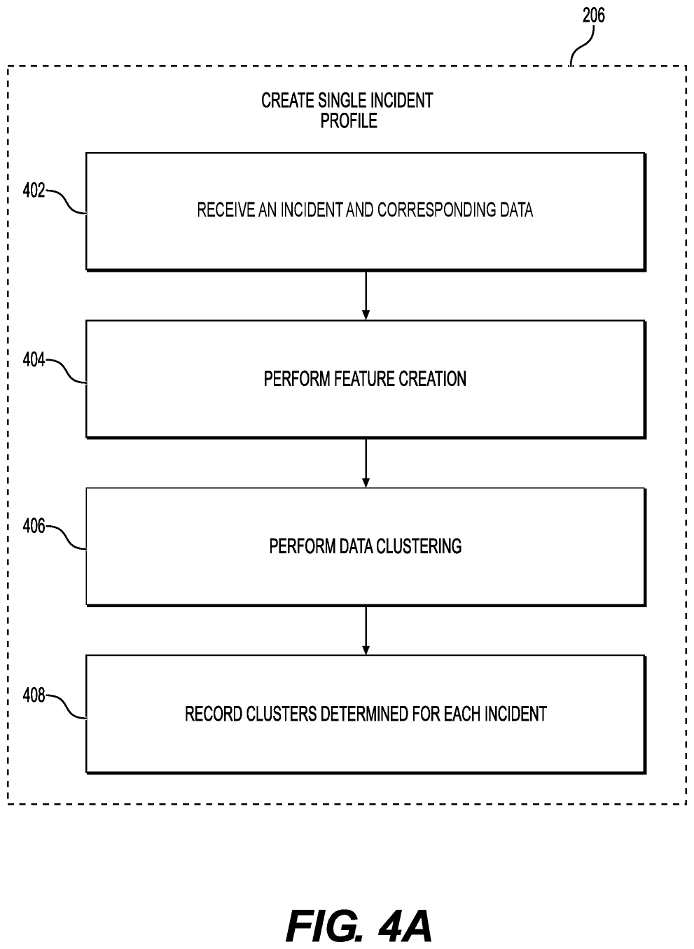

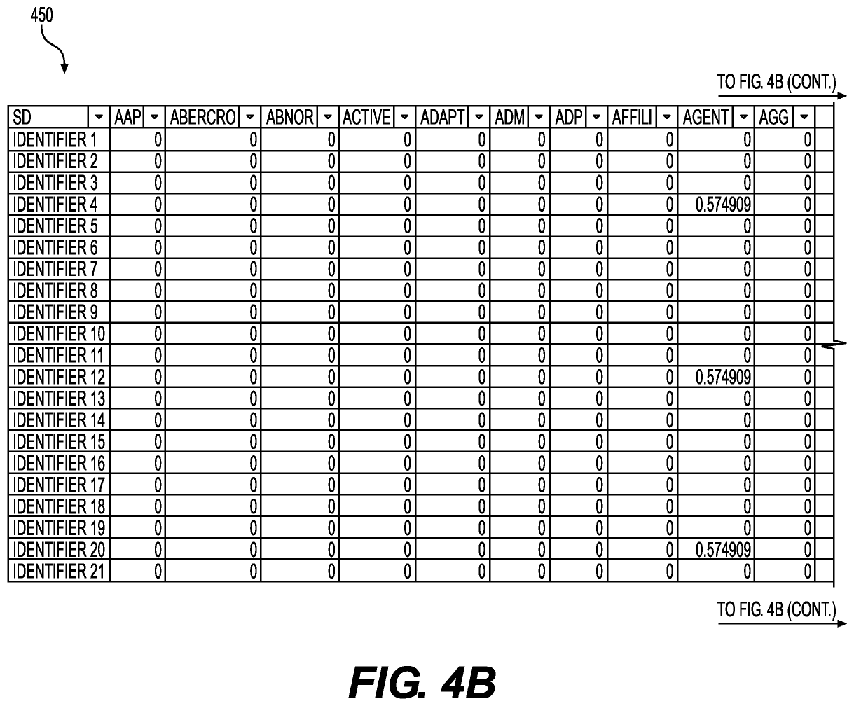

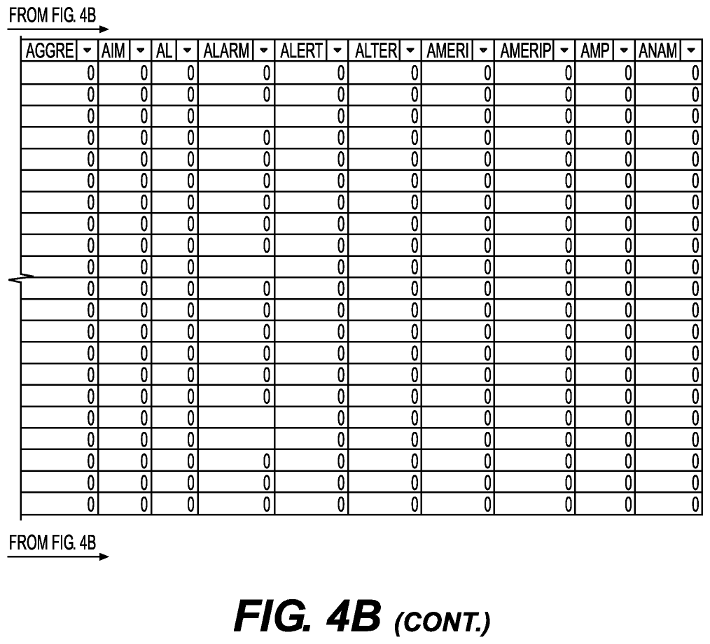

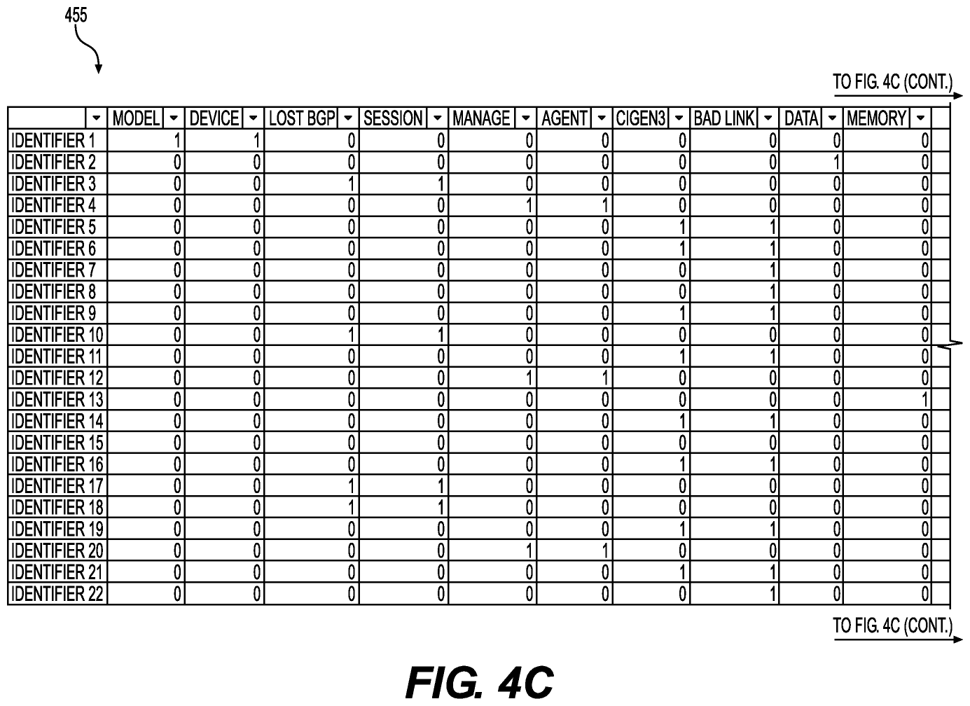

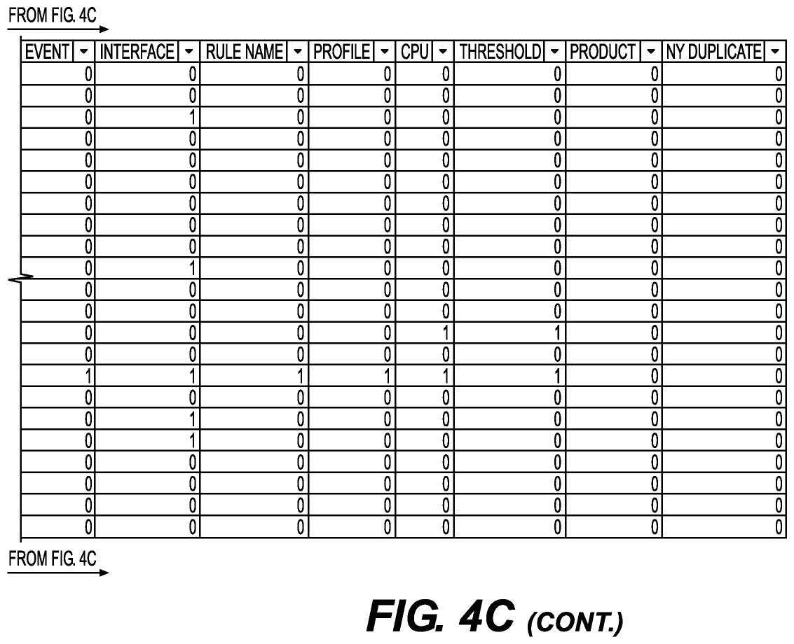

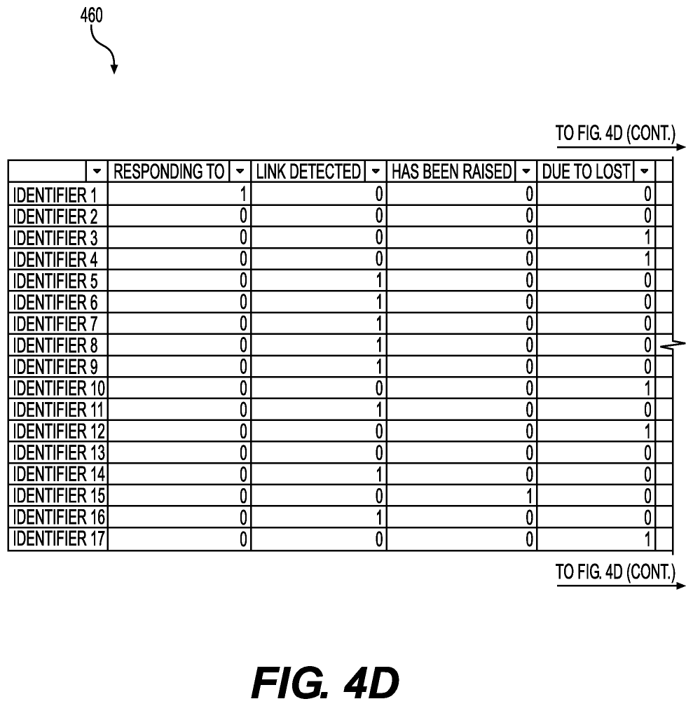

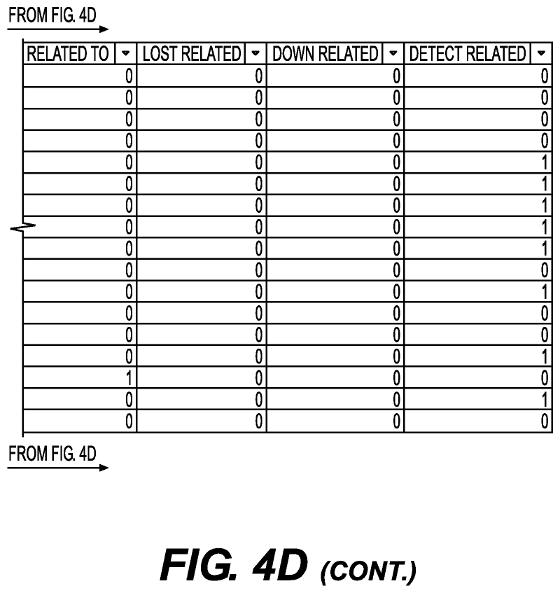

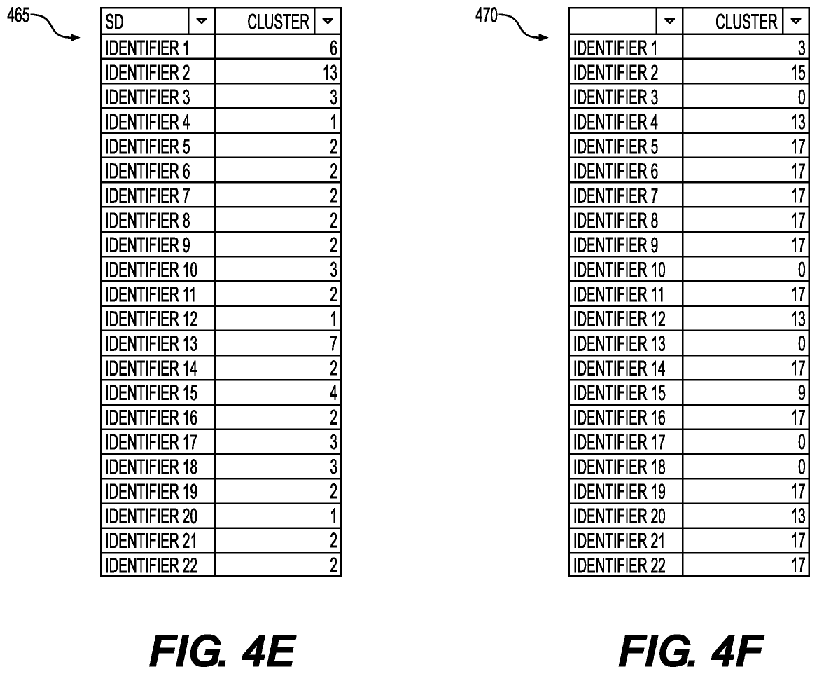

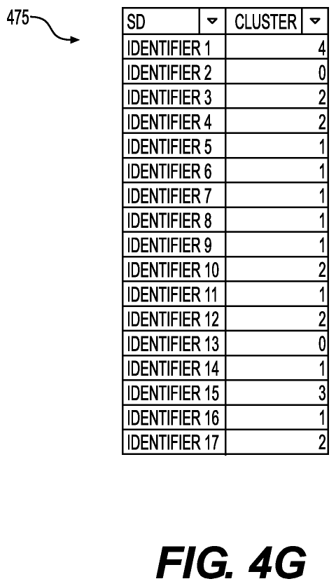

Upon receiving incident data at step 202, the system may further create a single incident profile at step 206. The flowchart 400 of FIG. 4A may depict step 206 in greater detail.

FIG. 4A depicts an exemplary method of determining a single incident profile, according to one or more embodiments. For example, at step 402, the system (e.g., system 100) may receive incident and corresponding data. This may for example include any of the data received at step 202. In particular, the incident data may include many individual incidents and each incident's corresponding characteristics. The incident characteristics may include the following, but is not limited to an incident number, date and time of the incident, a short description of the incident, and priority information. The short description may be free form text contain additional information about the incident such as the configuration item (“CI”), what businesses are effected by the incident, what type of category, sub-category, and who is assigned groups for the particular incident.

At step 404, the system may for example identify one or more sets of incident features for each received incident. This may be referred to as feature creation for a single incident. The incident features may for example be key aspects of information regarding a particular incident. The system may determine features by analyzing the text descriptions of each received incident. The system may utilize machine learning techniques such as natural language processing modules to determine and extract a set of incident features for one or more incidents. The system may utilize natural language processing (NLP) techniques or procedures to determine a set of incident features. For example, the natural language processing techniques may include utilizing linear discriminant analysis and/or Gibbs Sampling Dirichlet Mixture Model to determine features.

In one example, the system may use three different techniques to determine three different sets of incident features. A first set of incident features may be extracted from incident's text description using term frequency-inverse document frequency algorithm (TD-IDF) vectorization. The TD-IDF may for example calculate how relevant word is in a series of text. The TD-IDF may output an array of terms along with TD-IDF values and return a list of feature names. A second set of incident features may be extracted using noun phrase extraction. A third set of features may be extracted using verb phrase extraction. The noun phrase extraction and verb phrase extraction may for example be performed using natural language processing techniques (e.g., performed by the artificial intelligence model 180). This may include using previously trained models, e.g., by supervised or un-supervised to determine verb phrases and noun phrases. In one example, the system may determine a first set of features, a second set of features, and a third set of features.

FIG. 4B depicts an exemplary graph 450 of features determined using a term frequency-inverse document frequency (TF-IDF) vectorization for single incident profiles, according to one or more embodiments. FIG. 4C depicts an exemplary graph 455 of features determined using a noun phrase extraction for single incident profiles, according to one or more embodiments. FIG. 4D depicts an exemplary graph 460 of features determined using a verb phrase extraction for single incident profiles, according to one or more embodiments. The top row of graphs 450, 455, and 460 may correspond to the incident features extracted. The far left column may list the received incident's identifier names. The graphs 450, 455, and 460 may for example depict the amount of times an incident's text description includes an identified feature from the determined features of step 404.

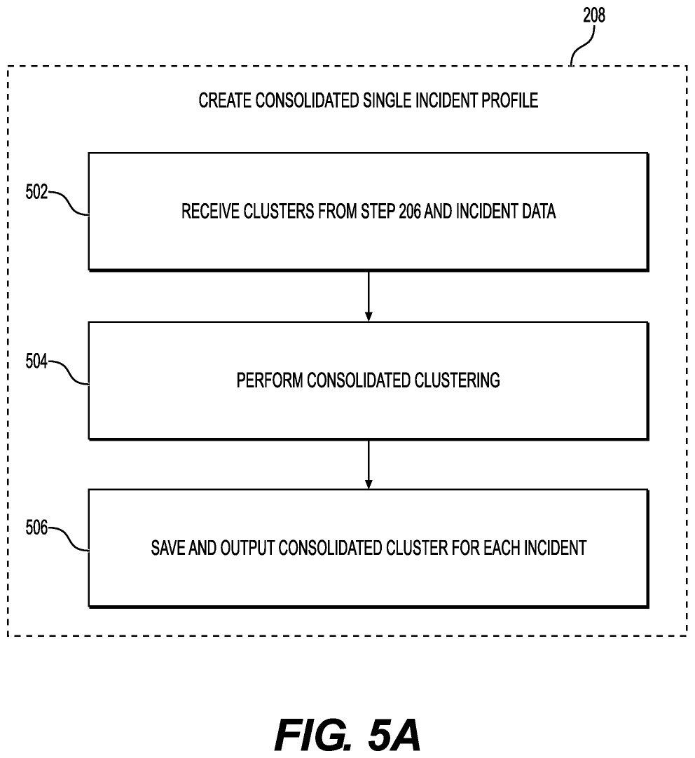

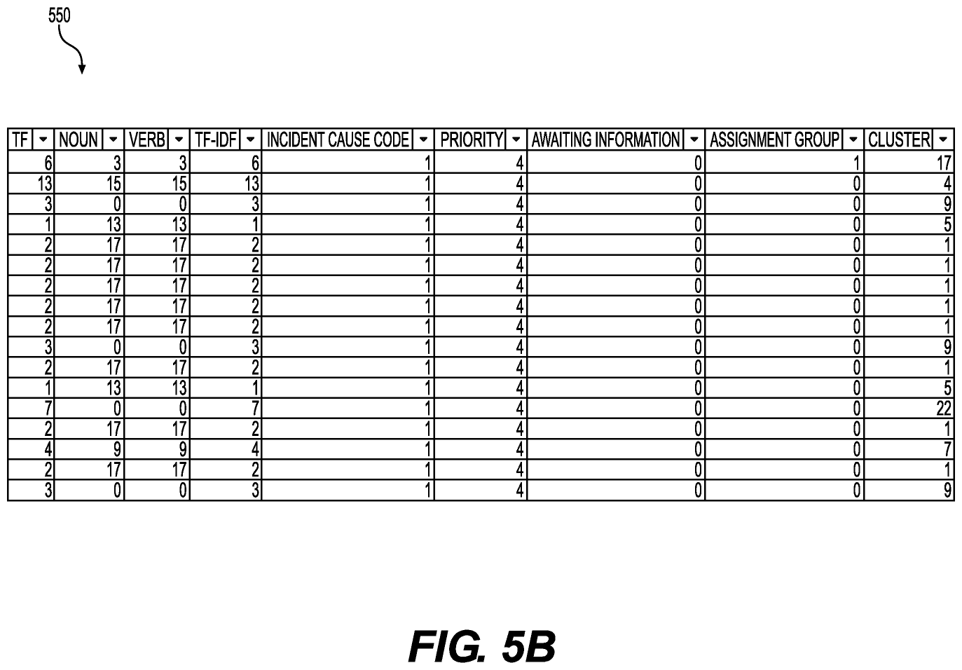

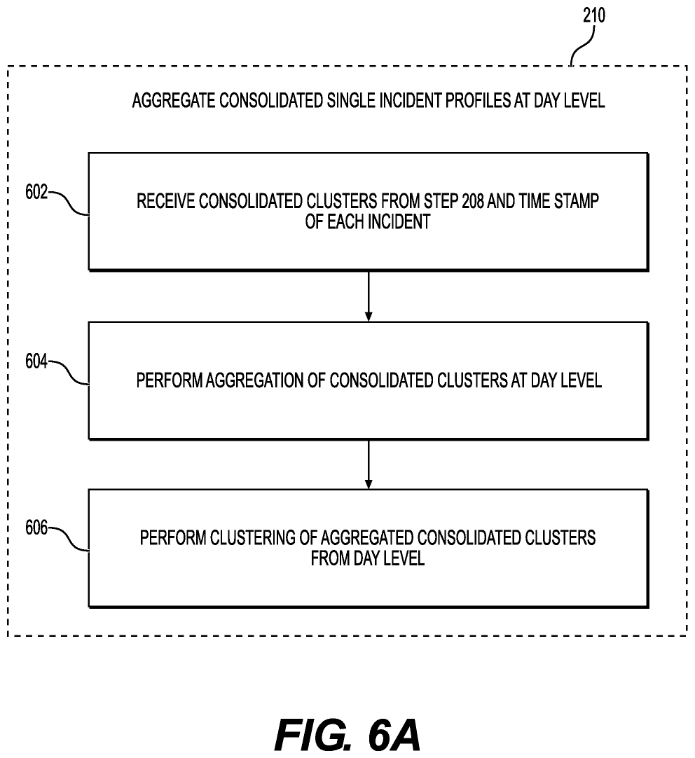

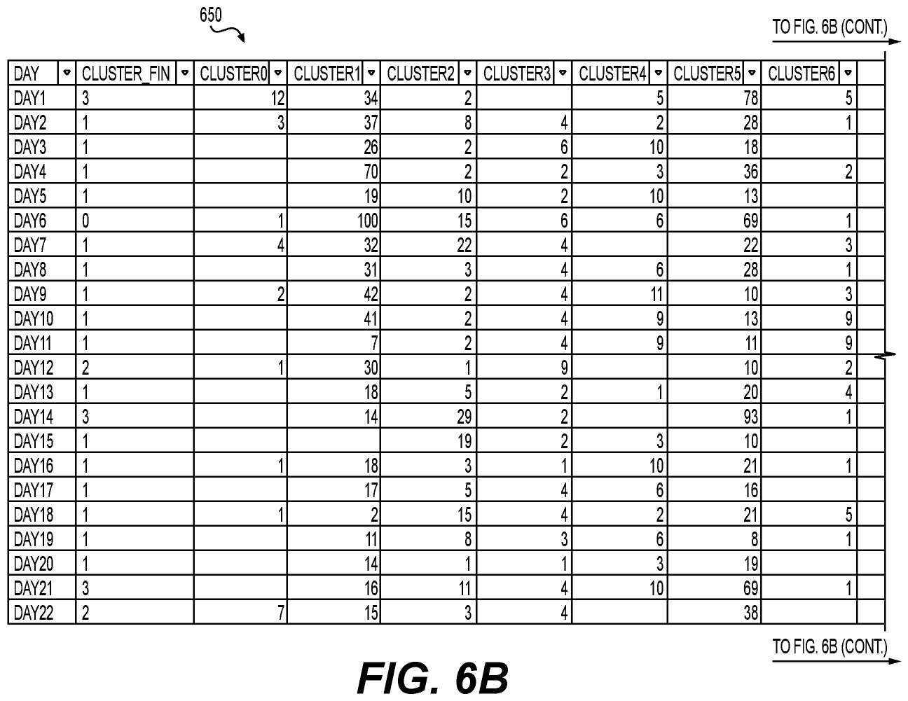

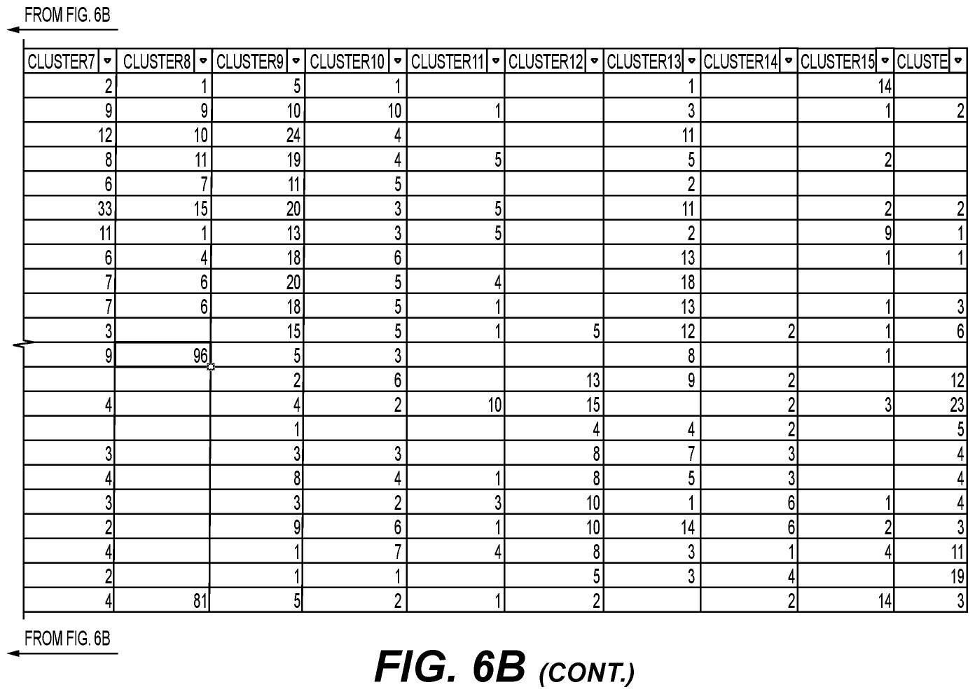

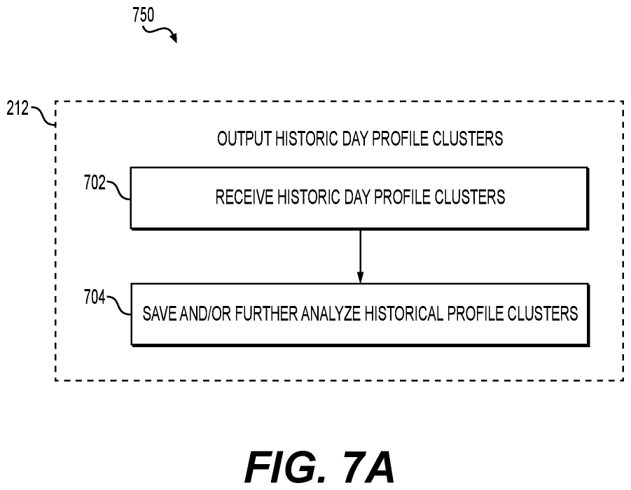

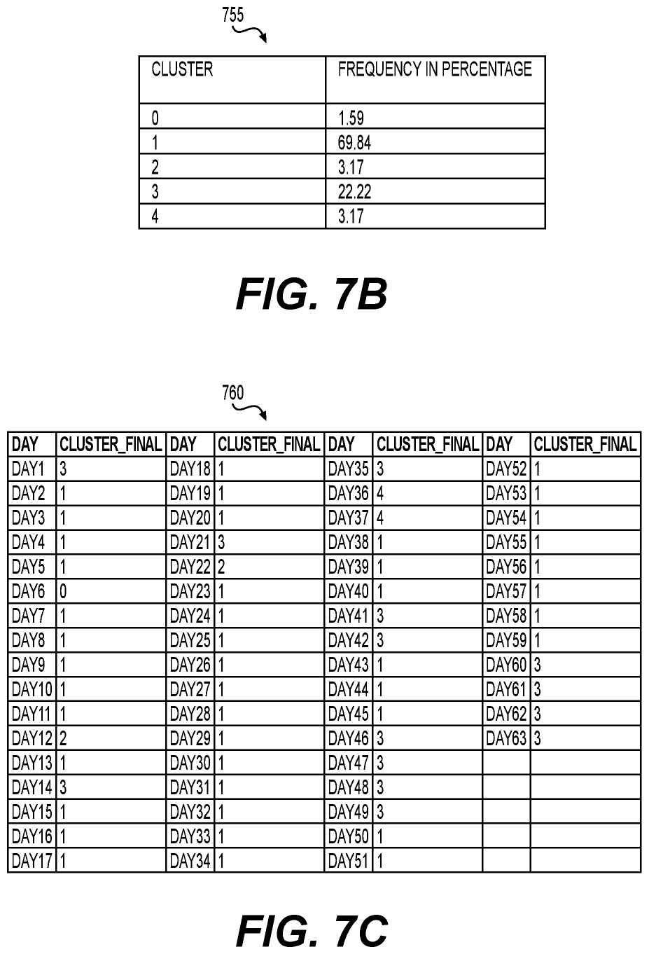

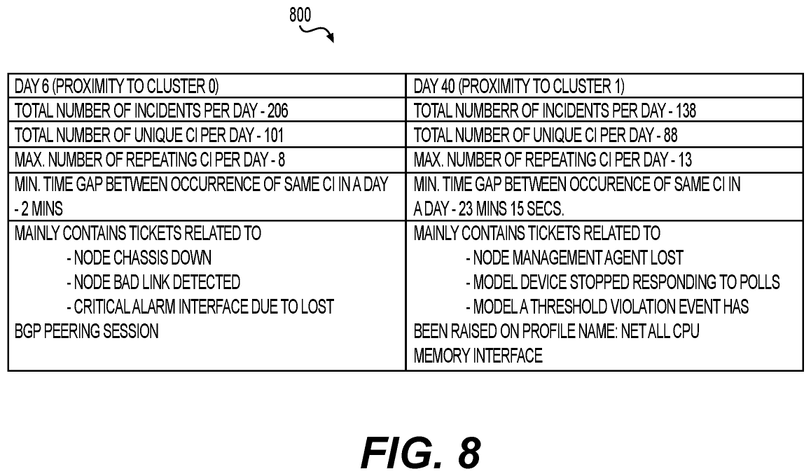

The exemplary graphs of FIG. 4B-4G, along FIG. 5B, FIG. 6B, FIG. 7A-7B, and FIG. 8 may correspond to outputs of the system 100 for a single set of exemplary incident data received over forty days. The outputs of these graphs may be exemplary outputs that that the systems described herein may create during the method 200 to determine the historic day profile clusters.

The graphs 450, 455, and 460 may depict where exemplary incidents had particular features within their short descriptions. For Example, FIG. 4B may display exemplary features determined utilizing the TD-IDF vectorization. FIG. 4C may display exemplary features determined utilizing noun phrase extract. FIG. 4D may display exemplary features determined utilizing verb phrase extract.

Upon determining the incident features that each incident includes (e.g., by extracting this information from the text description of each incident utilizing the techniques discussed at step 404), the system may proceed to step 406. At step 406, the system may perform a clustering algorithm on the incident's and their corresponding features. The system may for example utilize the clustering algorithms described at step 306. Applying the clustering algorithm may assign each incident to a particular cluster based on the extracted daily features. This may be performed for each set of features identified. For example, if three sets of features were identified at step 404, then three clusters may be assigned for each incident analyzed. A clustering algorithm may thus be applied separately on: (1) the incidents and corresponding features determined by TD-IDF vectorization; (2) the incidents and corresponding features determined by noun phrase extract; and/or (3) the incidents corresponding features determined by verb phrase extract. FIGS. 4E-4G may display an exemplary output of the clustering algorithms applied at step 406 for the three sets of features shown in FIG. 4B-FIG. 4D.

FIG. 4E depicts an exemplary graph 465 of clustered features determined using a term frequency-inverse document frequency (TF-IDF) vectorization for single incident profiles, according to one or more embodiments. FIG. 4F depicts an exemplary graph 470 of clustered features determined using a noun phrase extraction for single incident profiles, according to one or more embodiments. FIG. 4G depicts an exemplary graph 475 of clustered features determined using a verb phrase extraction for single incident profiles, according to one or more embodiments. FIG. 4E may display exemplary single incident clusters determined based on incident features extracted by the TD-IDF vectorization. FIG. 4F may display exemplary single incident clusters determined based on features extracted by noun phrase extract. FIG. 4G may display exemplary single incident clusters determined based on features extracted by verb phrase extract.

At step 408, each cluster determined for a particular incident may be saved and recorded. Each incident may then include three saved clusters. One cluster may be based on the determined incident features from TD-IDF vectorization, one cluster may be based on the determined incident features from the noun phrase extract, and one cluster may be based on the determined incident features from the verb phrase extract.

A single incident profile may be created for each incident. The single incident profile may store the determined clusters from step 406 for further analysis along with an incident identifier and additional data received from step 202.

Upon completion of step 408 (and correspondingly step 206), the system may proceed with step 208 displayed in FIG. 2A. At step 210, the system may create consolidated single incident profiles shown in FIG. 5A.

FIG. 5A depicts an exemplary flowchart for creating consolidated single incident profile, according to one or more embodiments.

At step 502, the system may first receive the clusters assigned to each incident from step 206 as well as an incident identifier and corresponding incident data. The system may next filter through the additional incident data to extract the following metadata: incident cause code, priority, awaiting information, and/or assignment group. The incident cause code may for example be codes used to track incident causes. This may be extracted from the text description of an incident or stored as separate metadata for each incident. For example, the received incident may include cause codes such as: configuration, data, environment, hardware, human error, integration, software, and/or third party, where the cause codes identify the cause of an incident. The priority may refer to a score that defines the relative importance of an incident. The priority may be assigned based on the impact or urgency of the incident. The priority for an incident may for example be assigned based on the urgency and priority level of a particular incident. The “awaiting information” may refer to whether an incident is awaiting additional information (e.g., from a customer, third party, or another team). This may be stored in the metadata of an incident. The awaiting information may either be assigned as score of zero if there is no additional information to receive or a 1 if the incident is awaiting information. The assignment group may refer to the team that is responsible for resolving the particular incident. This may have been preassigned based on the configurable item that was influenced by the incident. At the end of step 502, the clusters from step 206 as well as the incident cause code, priority, awaiting information, and/or assignment group may be grouped for each incident received and assigned to the consolidated single incident profile. The consolidated single incident profile may then be further analyzed.

At step 504, a clustering algorithm may be applied to each incident based on it's consolidated single incident profile. The clustering algorithm may group days based on their consolidated single incident profiles (e.g., based on having similar clusters from step 206 as well as similar incident cause code, priority, awaiting information, and/or assignment group). This may be depicted in FIG. 5B which displays an exemplary graph 550 of consolidated single incident profiles, according to one or more embodiments. As shown in FIG. 5B, the consolidated single incident profiles may each be clustered into a particular cluster based on the consolidated single incident profile. The determined clusters may be referred to as the consolidated single incident profile clusters. The exemplary consolidated single incident profile clusters may for example be shown in the far right column of graph 550. Any of the clustering algorithms described within this application may be applied at step 504. The consolidated single incident profile clusters may group incidents with similar consolidated single incident profiles.

At step 506, the consolidated single incident profile clusters may be saved for further analysis.

Upon completion of step 506 (and correspondingly step 208), the system may proceed with step 210 displayed in FIG. 2A. At step 210, the system may aggregate consolidated single incident profiles at a day level as shown in FIG. 6A.

FIG. 6A depicts an exemplary flowchart for aggregating consolidated single incident profiles at a day level, according to one or more embodiments.

At step 602, the system may receive all of the consolidated single incident profile clusters from step 208. At this point in the analysis, each received incident may have an assigned consolidated single incident profile cluster.

At step 604, utilizing incidents time and date stamp, all incidents for a particular day may be grouped together. Next, for each day, the system may identify how many incidents belong to each of the consolidated single incident profile clusters from step 208. These may be recorded for each day.

For an example scenario, the system may determine that for a first day 160 incidents were received. Of the 160 incidents received, 12 incidents had a consolidated single incident profile cluster 0, 35 incidents had a consolidated single incident profile cluster 1, 2 incidents had a consolidated single incident profile cluster of 2, 0 incidents had a consolidated single incident profile cluster 3, 5 incidents had a consolidated single incident profile cluster of 4, 78 incidents had a consolidated single incident profile cluster 5, 5 incidents had a consolidated single incident profile cluster 6, 2 incidents had a consolidated single incident profile cluster 7, 1 incident had a consolidated single incident profile cluster 8, 5 incidents had a consolidated single incident profile cluster 9, 1 incident had a consolidated single incident profile cluster 10, 0 incidents had consolidated single incident profile clusters of 11 or 12, 1 incident had a consolidated single include profile cluster 13, 0 incidents had a consolidated single incident profile cluster 14, 14 incidents had a consolidated single incident profile cluster of 15, and 0 incidents had a consolidated single incident profile cluster 16. This may be done for a set amount of days (e.g., for a week, for a month, for three months, 100 days, a year, twenty two days, etc.). In this example, this may have been performed for 22 days (as displayed in FIG. 6B).

At step 606, the system may perform clustering of the aggregated consolidated clusters at a day level. The system may for example use any of the clustering techniques described herein to perform this. Upon performing the clustering algorithm, each day may thus be assigned a “historic day profile cluster.” The assigned clusters may provide insight into the all incidents received throughout a particular day.

FIG. 6B depicts an exemplary graph 650 of aggregated consolidated single incident profiles at a day level, according to the example of step 604. For graph 650, the second column from the far left may show the historic day profile cluster for the example scenario.

Upon completion of step 606 (and correspondingly step 210), the system may proceed with step 212 displayed in FIG. 2A. At step 212, the system may output the historic day profile clusters as shown in FIG. 7A. Outputting may refer to storing or sending the clusters for further analysis.

FIG. 7A depicts an exemplary flowchart for outputting historic day profile clusters, according to one or more embodiments.

At step 702, the system may receive the historic day profile clusters from step 210.

At step 704, the system may save and/or further analyze the received historic day profile clusters. For example, each day may have a historic day profile cluster recorded and saved. For example, FIG. 7C depicts an exemplary graph 760 of the determined historic day profile clusters saved for the example scenario of FIG. 6A.

Further, at step 704, for a set period of days, the frequency of a particular cluster over the period of days may be calculated. This may be calculated by dividing the number of days with a particular historic day profile cluster divided by the total amount of days. FIG. 7B depicts an exemplary graph 755 of the frequency of particular historic day profile clusters, for the example scenario. In the example scenario, five historic day profile clusters may have been determined, wherein cluster 1 represented 69.84% of the days where incidents were received. The system may for example determine that the most common historic day profile cluster is assigned a benchmark or normal operation day.

Analysis may be performed on each of the daily profile within a particular historic day profile cluster. For example, the total number of incidents per day, total number of unique CI per day, the max number of repeating CI per day, the minimum time gap between occurrences of the same CI in a day, as well as extracted info from the metadata may be extracted for each day of a particular historic day profile cluster. This information may be aggregated for each day and averages of the above may be determined for each type of cluster. FIG. 8 depicts exemplary graph displaying a comparison between two days of incident data, according to the example scenario described herein.

The methods and systems described herein may be configured to capture and group incident data from individual days that more accurately groups days based on the complexity of incidents.

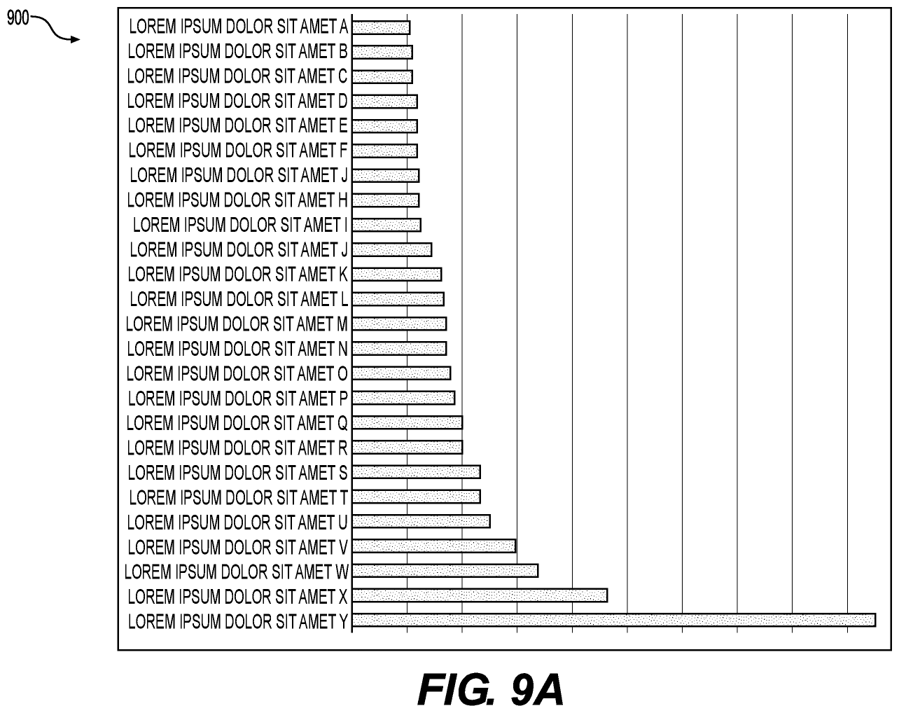

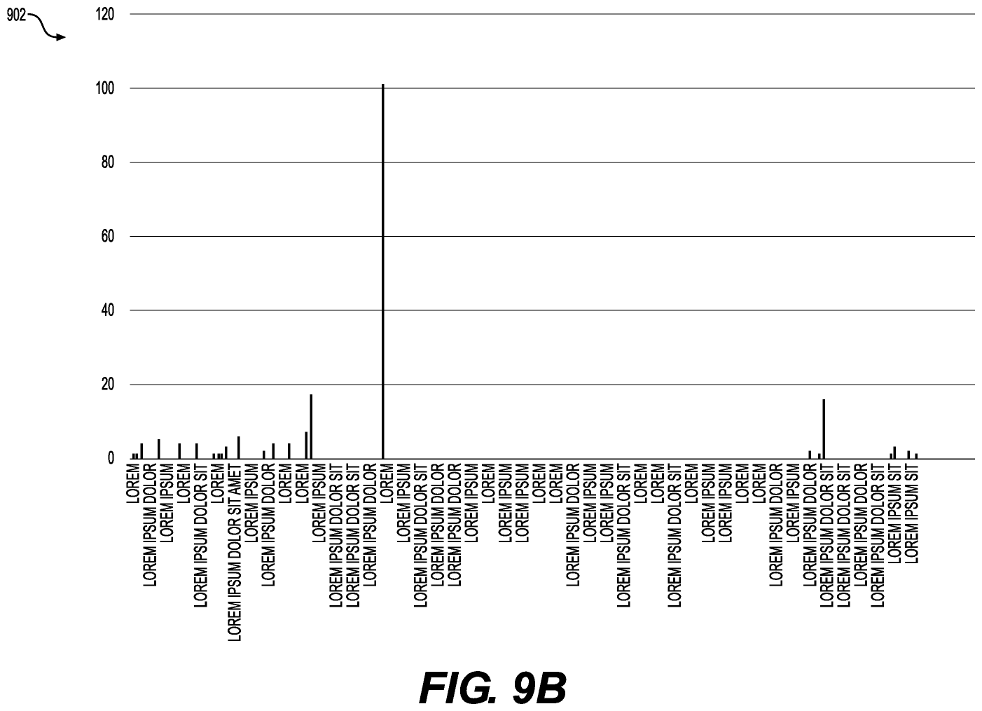

FIG. 9A-11 depicts exemplary graphs that may be output from the system and devices described herein.

FIG. 9A-9B may depict exemplary graph outputs of the same day profile created for on an exemplary day (e.g., corresponding to the step 204), according to one or more embodiments. For example, the graph 900 and graph 902 may be an output of the system described herein. For example, when a day profile is created (e.g., at step 204 or step 210), the system may be configured to output a graph 900 detailing all configurable items affected by incidents in a particular day. This may for example, allow for a user to quickly see what configurable items were affected most and least for a particular day using the techniques and methods described herein. The system may further be configured to compile incidents that have been reported multiple times. For example, duplicate tickets (e.g., tickets that report an incident) may be received. The day profile may be configured to recognize and output the amount of duplicate tickets with closure code. For example duplicate tickets may have been created for multiple tickets being created for the same issue, a ticket being created for a previously resolve disused, a ticket may be created for an issue outside of the scope of an IT service management. The Y-column of graph 900 may for example depict exemplary configurable item names, and the graph 900 may depict how many duplicative tickets were created for the exemplary configurable items over a day. Graph 902 may include exemplary closure codes in the x axis. Closure codes for a configurable item may refer to the code that indicates the reason why a particular configurable item incident has been resolved. This may depict the incidents (e.g., reported with their corresponding ticket) that may be ignored at a daily level when reported more than once. Thus, the information generated by the daily profile may be useful for review from an IT management system.

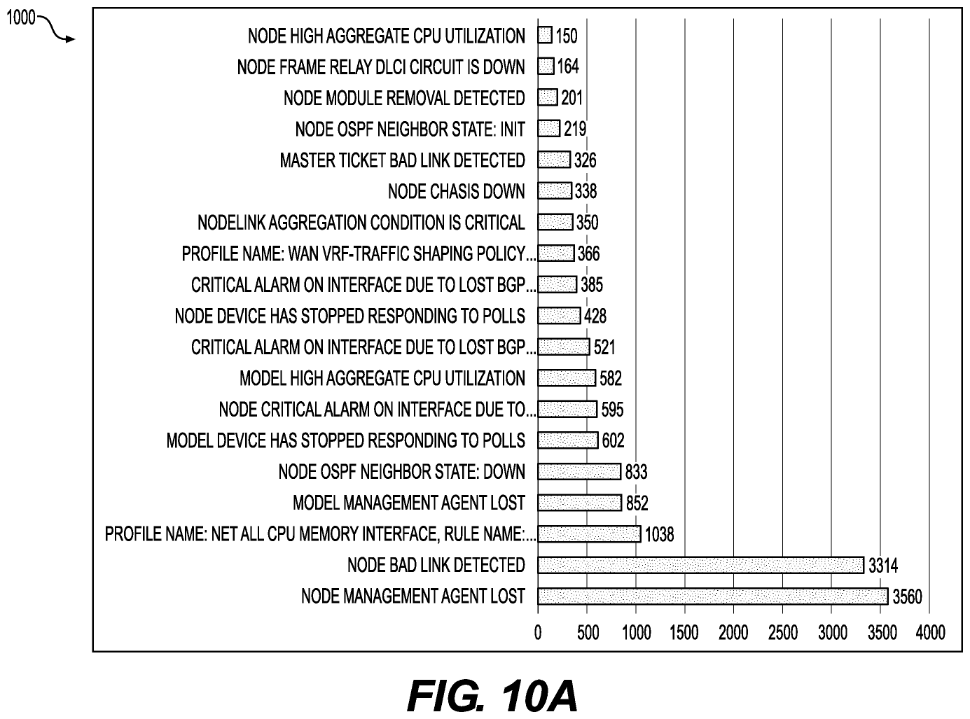

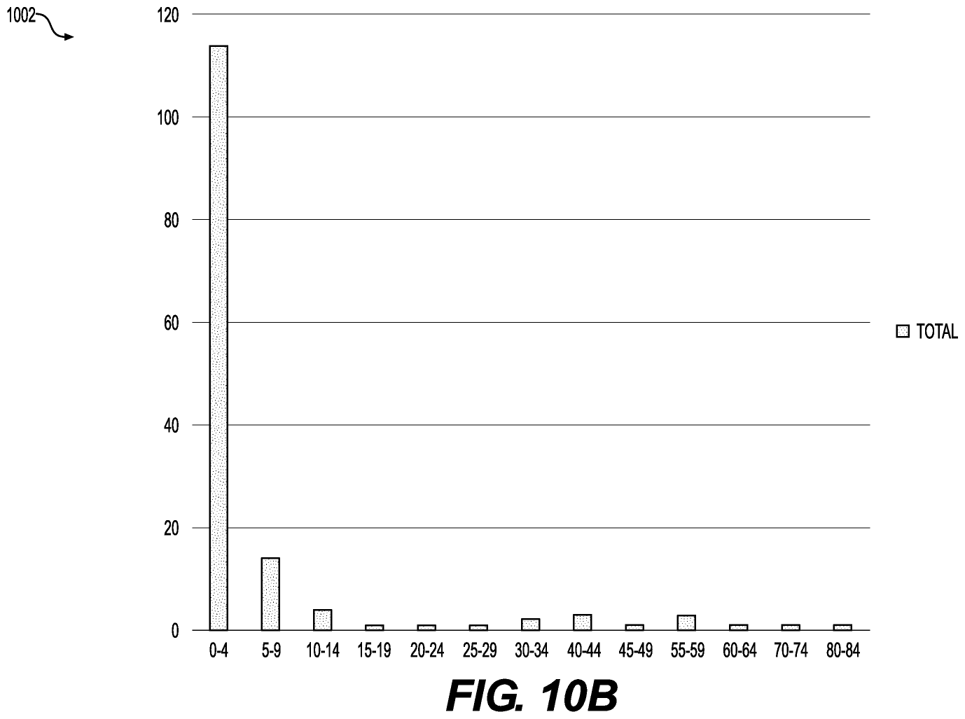

FIG. 10A depicts an exemplary graph 1000 output of the top contributing alerts for incidents on an exemplary day, according to one or more embodiments. FIG. 10A may include the system described herein compiling all incident data for a day including alerts received. The alerts may refer to the notification generated by a monitoring system that reports incidents. The systems described herein may compile the type of alerts sent. The system may, aggregate all type of alerts received in a particular day and graph/output this information as displayed in graph 1000.

FIG. 10B depicts an exemplary graph 1002 output of the minimum time gap between incidents for the same configurable item, according to one or more embodiments. The minimum time gap may for example have been identified at step 204. This time may be recorded and graphed for a user to examine and analyze the incident data received over a day.

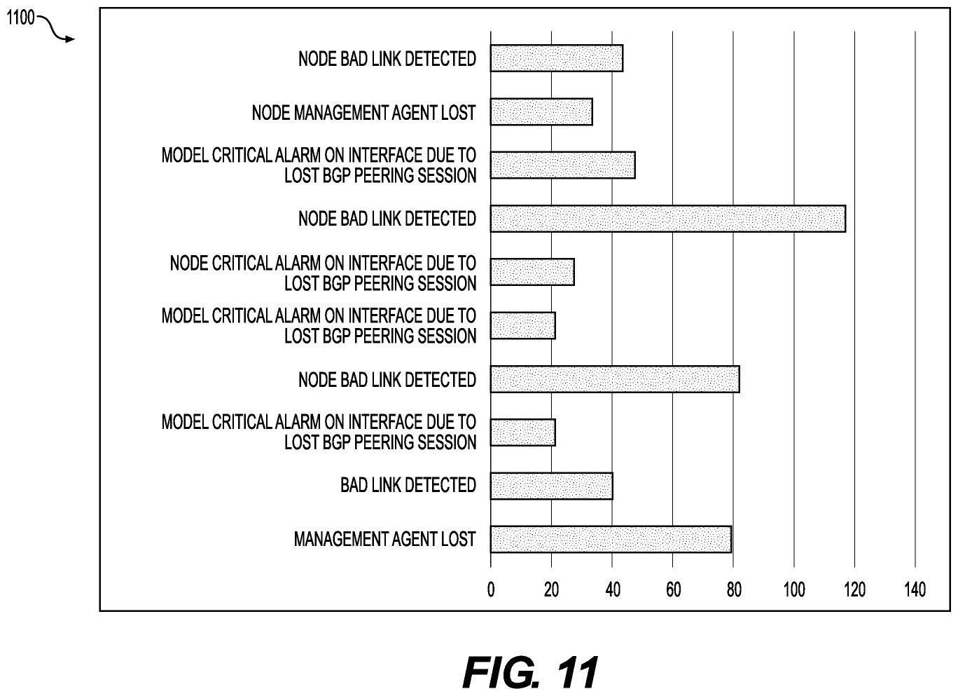

FIG. 11 depicts an exemplary graph 1100 output of the frequently occurring incidents in an exemplary day, according to one or more embodiments. For example, the summaries may correspond to features extracted at step 206. Repeating features within a single day may be graphed and displayed as shown in graph 1100.

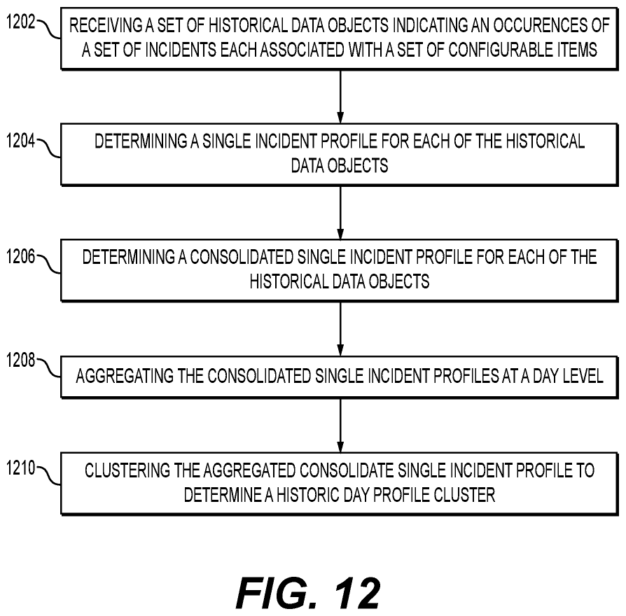

FIG. 12 of a flowchart 1200 of a method for aggregating and mapping incident characteristics into a daily profile.

At step 1202, a set of historical data objects indicating an occurrences of a set of incidents each associated with a set of configurable items may be received.

At step 1204, a single incident profile may be determined for each of the historical data objects.

At step 1206, a consolidated single incident profile may be determined for each of the historical data objects.

At step 1208, consolidated single incident profiles may be aggregated at a day level.

At step 1210, the aggregated consolidate single incident profiles may be clustered to determine a historic day profile cluster.

FIG. 13 illustrates a computer system 1300 for executing the techniques described herein, according to one or more embodiments of the present disclosure.

In addition to a standard desktop, or server, it is fully within the scope of this disclosure that any computer system capable of the required storage and processing demands would be suitable for practicing the embodiments of the present disclosure. This may include tablet devices, smart phones, pin pad devices, and any other computer devices, whether mobile or even distributed on a network (i.e., cloud based).

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

FIG. 13 illustrates a computer system designated 1300. The computer system 1300 can include a set of instructions that can be executed to cause the computer system 1300 to perform any one or more of the methods or computer based functions disclosed herein. The computer system 1300 may operate as a standalone device or may be connected, e.g., using a network, to other computer systems or peripheral devices.

In a networked deployment, the computer system 1300 may operate in the capacity of a server or as a client user computer in a server-client user network environment, or as a peer computer system in a peer-to-peer (or distributed) network environment. The computer system 1300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 1300 can be implemented using electronic devices that provide voice, video, or data communication. Further, while a single computer system 1300 is illustrated, the term “system” shall also be taken to include any collection of systems or sub-systems that individually or jointly execute a set, or multiple sets, of instructions to perform one or more computer functions.

As illustrated in FIG. 13, the computer system 1300 may include a processor 1302, e.g., a central processing unit (CPU), a graphics processing unit (GPU), or both. The processor 1302 may be a component in a variety of systems. For example, the processor 1302 may be part of a standard personal computer or a workstation. The processor 1302 may be one or more general processors, digital signal processors, application specific integrated circuits, field programmable gate arrays, servers, networks, digital circuits, analog circuits, combinations thereof, or other now known or later developed devices for analyzing and processing data. The processor 1302 may implement a software program, such as code generated manually (i.e., programmed).

The computer system 1300 may include a memory 1304 that can communicate via a bus 1308. The memory 1304 may be a main memory, a static memory, or a dynamic memory. The memory 1304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 1304 includes a cache or random-access memory for the processor 1302. In alternative implementations, the memory 1304 is separate from the processor 1302, such as a cache memory of a processor, the system memory, or other memory. The memory 1304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1304 is operable to store instructions executable by the processor 1302. The functions, acts or tasks illustrated in the figures or described herein may be performed by the programmed processor 1302 executing the instructions stored in the memory 1304. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel payment and the like.

As shown, the computer system 1300 may further include a display unit 1310, such as a liquid crystal display (LCD), an organic light emitting diode (OLED), a flat panel display, a solid-state display, a cathode ray tube (CRT), a projector, a printer or other now known or later developed display device for outputting determined information. The display 1310 may act as an interface for the user to see the functioning of the processor 1302, or specifically as an interface with the software stored in the memory 1304 or in the drive unit 1306.

Additionally or alternatively, the computer system 1300 may include an input device 1312 configured to allow a user to interact with any of the components of system 1300. The input device 1312 may be a number pad, a keyboard, or a cursor control device, such as a mouse, or a joystick, touch screen display, remote control, or any other device operative to interact with the computer system 1300.

The computer system 1300 may also or alternatively include a disk or optical drive unit 1306. The disk drive unit 1306 may include a computer-readable medium 1322 in which one or more sets of instructions 1324, e.g., software, can be embedded. Further, the instructions 1324 may embody one or more of the methods or logic as described herein. The instructions 1324 may reside completely or partially within the memory 1304 and/or within the processor 1302 during execution by the computer system 1300. The memory 1304 and the processor 1302 also may include computer-readable media as discussed above.

In some systems, a computer-readable medium 1322 includes instructions 1324 or receives and executes instructions 1324 responsive to a propagated signal so that a device connected to a network 1370 can communicate voice, video, audio, images, or any other data over the network 1370. Further, the instructions 1324 may be transmitted or received over the network 1370 via a communication port or interface 1320, and/or using a bus 1308. The communication port or interface 1320 may be a part of the processor 1302 or may be a separate component. The communication port 1320 may be created in software or may be a physical connection in hardware. The communication port 1320 may be configured to connect with a network 1370, external media, the display 1310, or any other components in system 1300, or combinations thereof. The connection with the network 1370 may be a physical connection, such as a wired Ethernet connection or may be established wirelessly as discussed below. Likewise, the additional connections with other components of the system 1300 may be physical connections or may be established wirelessly. The network 1370 may alternatively be directly connected to the bus 1308.

While the computer-readable medium 1322 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 1322 may be non-transitory, and may be tangible.

The computer-readable medium 1322 can include a solid-state memory such as a memory card or other package that houses one or more non-volatile read-only memories. The computer-readable medium 1322 can be a random-access memory or other volatile re-writable memory. Additionally or alternatively, the computer-readable medium 1322 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 1300 may be connected to one or more networks 1370. The network 1370 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 1370 may include wide area networks (WAN), such as the Internet, local area networks (LAN), campus area networks, metropolitan area networks, a direct connection such as through a Universal Serial Bus (USB) port, or any other networks that may allow for data communication. The network 1370 may be configured to couple one computing device to another computing device to enable communication of data between the devices. The network 1370 may generally be enabled to employ any form of machine-readable media for communicating information from one device to another. The network 1370 may include communication methods by which information may travel between computing devices. The network 1370 may be divided into sub-networks. The sub-networks may allow access to all of the other components connected thereto or the sub-networks may restrict access between the components. The network 1370 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel payment. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP, etc.) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments, various features of the embodiments are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that a claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the function.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer implemented method for aggregating and mapping incident characteristics into a daily profile, the method comprising:
receiving a set of historical data objects indicating an occurrences of a set of incidents each associated with a set of configurable items;
determining a single incident profile for each of the historical data objects;
determining a consolidated single incident profile for each of the historical data objects;
aggregating the consolidated single incident profiles at a day level; and
clustering the aggregated consolidate single incident profile to determine a historic day profile cluster.

2. The method of claim 1, wherein the set of historical data objects represents the occurrences of a set of incidents over at least a month.

3. The method of claim 1, where determining a single incident profile for each of the historical data objects includes:
determining features from text descriptions of the historical data objects;
performing a clustering algorithm on the features; and
determining clusters for each of the historical data objects.

4. The method of claim 3, further including:
determining a first set of features utilizing term frequency-inverse document frequency vectorization;
determining a second set of features utilizing noun phrase extraction; and
determining a third set of features utilizing verb phrase extraction.

5. The method of claim 4, wherein the clustering algorithms are applied separately on the first set of features, the second set of feature, and the third set of features.

6. The method of claim 1, wherein determining a consolidated single incident profile for each of the historical data objects further includes:
applying a clustering algorithm on the consolidated single incident profile; and
saving a single incident cluster for each historical data object.

7. The method of claim 6, wherein aggregating the consolidated single incident profiles at a day level further includes:
performing a clustering algorithm on the consolidated single incident profiles, wherein the single incident profiles at a day level has an aggregation of all single incident clusters for each historical data object for a day.

8. The method of claim 1, further including:
outputting the historic day profile clusters for a set period of time.

9. The method of claim 8, further including;
determining an amount of days within each of the determined historic day profile clusters.

10. A system for aggregating and mapping incident characteristics into a daily profile, the system comprising:
a memory having processor-readable instructions stored therein; and
at least one processor configured to access the memory and execute the processor-readable instructions to perform operations including:
receiving a set of historical data objects indicating an occurrences of a set of incidents each associated with a set of configurable items;
determining a single incident profile for each of the historical data objects;
determining a consolidated single incident profile for each of the historical data objects;
aggregating the consolidated single incident profiles at a day level; and
clustering the aggregated consolidate single incident profile to determine a historic day profile cluster.

11. The system of claim 10, wherein the set of historical data objects represents the occurrences of a set of incidents over at least a month.

12. The system of claim 10, where determining a single incident profile for each of the historical data objects includes:
determining features from text descriptions of the historical data objects;
performing a clustering algorithm on the features; and
determining clusters for each of the historical data objects.

13. The system of claim 12, further including:
determining a first set of features utilizing term frequency-inverse document frequency vectorization;
determining a second set of features utilizing noun phrase extraction; and
determining a third set of features utilizing verb phrase extraction.

14. The system of claim 13, wherein the clustering algorithms are applied separately on the first set of features, the second set of feature, and the third set of features.

15. The system of claim 10, wherein determining a consolidated single incident profile for each of the historical data objects further includes:
applying a clustering algorithm on the consolidated single incident profile; and
saving a single incident cluster for each historical data object.

16. The system of claim 15, wherein aggregating the consolidated single incident profiles at a day level further includes:
performing a clustering algorithm on the consolidated single incident profiles, wherein the single incident profiles at a day level has an aggregation of all single incident clusters for each historical data object for a day.

17. The system of claim 10, further including:
outputting the historic day profile clusters for a set period of time.

18. The system of claim 17, further including;
determining an amount of days within each of the determined historic day profile clusters.

19. A non-transitory computer readable medium storing processor-readable instructions which, when executed by at least one processor, cause the at least one processor to perform operations including:
receiving a set of historical data objects indicating an occurrences of a set of incidents each associated with a set of configurable items;
determining a single incident profile for each of the historical data objects;
determining a consolidated single incident profile for each of the historical data objects;
aggregating the consolidated single incident profiles at a day level; and
clustering the aggregated consolidate single incident profile to determine a historic day profile cluster.

20. The non-transitory computer readable medium of claim 19, wherein the set of historical data objects represents the occurrences of a set of incidents over at least a month.
